(19) United States
(12) Patent Application Publication
(10) Pub. No.: US 2024/0171218 A1
(43) Pub. Date: May 23, 2024

(54) SYSTEMS AND METHODS FOR MACHINE LEARNING BASED FOREIGN OBJECT DETECTION FOR WIRELESS POWER TRANSMISSION

(71) Applicant: Energous Corporation, San Jose, CA (US)

(72) Inventors: Howard CHAN, San Jose, CA (US); Deepak JAIN, San Ramon, CA (US)

(21) Appl. No.: 18/522,082

(22) Filed: Nov. 28, 2023

Related U.S. Application Data
(63) Continuation of application No. 17/831,037, filed on Jun. 2, 2022, now Pat. No. 11,831,361.
Application No. 17/831,037 is a continuation of application No. 17/026,196, filed on Sep. 19, 2020, now Pat. No. 11,381,118.
(60) Provisional application No. 62/903,674, filed on Sep. 20, 2019.

(51) Int. Cl. H04B 5/79; H02J 50/20; H02J 50/40; H02J 50/60

(52) U.S. Cl. CPC H04B 5/79; H02J 50/20; H02J 50/402; H02J 50/60

(57) ABSTRACT

An example method is provided for detecting and classifying foreign objects, performed at a computer system having one or more processors and memory storing one or more programs configured for execution by the one or more processors. The method includes obtaining a plurality of electrical measurements while a wireless-power-transmitting antenna is transmitting different power beacons. The method also includes forming a feature vector according to the plurality of electrical measurements. The method further includes detecting a presence of one or more foreign objects prior to transmitting wireless power to one or more wireless power receivers by inputting the feature vector to trained one or more classifiers, wherein each classifier is a machine-learning model trained to detect foreign objects distinct from the one or more wireless power receivers.

### RELATED APPLICATIONS

This application is a continuation of U.S. patent application Ser. No. 17/831,037, filed on Jun. 2, 2022, entitled “Systems And Methods For Machine Learning Based Foreign Object Detection For Wireless Power Transmission,” which is a continuation of U.S. patent application Ser. No. 17/026,196, filed on Sep. 19, 2020 (now U.S. Pat. No. 11,381,118), entitled “Systems And Methods For Machine Learning Based Foreign Object Detection For Wireless Power Transmission,” which claims priority to U.S. Provisional Application Ser. No. 62/903,674, filed Sep. 20, 2019, entitled “Systems And Methods For Machine Learning Based Foreign Object Detection For Wireless Power Transmission,” each of which is incorporated by reference herein in its entirety.

This application is related to U.S. patent application Ser. No. 17/026,191, which claims priority from Provisional Application Ser. No. 62/903,677, filed Sep. 20, 2019, entitled “Classifying And Detecting Foreign Objects Using A Power Amplifier Controller Integrated Circuit In Wireless Power Transmission Systems,” each of which is incorporated by reference herein in its entirety.

This application is related to U.S. patent application Ser. No. 16/045,637, entitled “Systems and Methods for Detecting Wireless Power Receivers and Other Objects at a Near-Field Charging Pad,” filed Jul. 25, 2018, which is incorporated herein in its entirety.

This application is related to PCT Patent Application No. PCT/US17/65886, filed Dec. 12, 2017, which is a continuation of U.S. Non-Provisional patent application Ser. No. 15/833,790, filed Dec. 6, 2017, which is a continuation-in-part of U.S. Non-Provisional patent application Ser. No. 15/424,552, filed Feb. 3, 2017, which claims priority to U.S. Provisional Application Ser. No. 62/433,227, filed Dec. 12, 2016. PCT Patent Application No. PCT/US17/65886 also claims priority to U.S. Provisional Application Ser. No. 62/541,581, filed Aug. 4, 2017. Each of these applications is hereby incorporated by reference in its respective entirety.

### TECHNICAL FIELD

The embodiments herein generally relate to antennas, software, and devices used in wireless power transmission systems and, more specifically, to systems and methods for machine-learning based foreign object detection for wireless power transmission.

### BACKGROUND

Building a wireless charging system for consumer devices typically requires complicated, and often, expensive antenna components to transmit and receive wirelessly delivered power. Conventionally, it is hard for a wireless power transmitter to accurately distinguish a valid wireless power receiver that needs to be charged, versus a foreign object that does not need to be charged. Users have encountered numerous frustrating issues with some conventional charging devices, including having damages caused to objects that include magnetic strips and/or RFID chips (e.g., credits cards, security badges, passports, key fobs, and the like). Moreover, many of these conventional charging devices typically require placing the device to be charged at a specific position around the wireless power transmitter, and the device may not be moved to different positions, without interrupting or terminating the charging of the device. This results in a frustrating experience for many users as they may be unable to locate the device at the exact right position within the charging field of the wireless power transmitter in which to start charging their device, and may further end up with damages to important objects that they use on a daily basis.

### SUMMARY

Accordingly, there is a need for wireless charging systems (e.g., radio frequency (RF) charging pads) that address the problems identified above. To this end, systems and methods are described herein that are capable of detecting and/or classifying objects for wireless power transmission. Such systems and methods of use thereof discover presence of objects in order to determine whether to proceed with delivery of wireless power or whether to forgo transmitting wireless power in order to avoid potentially damaging any of the detected objects. Such systems identify wireless power receivers and/or ignore one or more wireless power receivers that are not to be charged or powered and, thereby, avoid power leeching and other drains on the system as a whole, while ensuring that authorized wireless power receivers always receive power.

The systems disclosed herein use machine learning models to detect the presence of and/or to classify objects (including objects that are not wireless power receivers) that are present on or near the system. The machine learning models are trained apriori using a known set of objects and/or a predetermined set of features. During the training phase, the system transmits test power transmission signals and then receives reflected power back from one or more wireless power receivers or from one or more objects. The reflected power is collected and analyzed to identify signature signals (selected features) to train the machine learning models. The machine learning models are subsequently used by the wireless power transmission system to determine whether an authorized device is present and/or to determine whether an object other than a wireless power receiver is present.

In some embodiments, the process for reflecting power works even if an authorized wireless power receiver has no power remaining (e.g., its battery is completely drained), as the wireless power receiver is able to harness energy from the test power transmission signals to create impedance changes at the receiver side, which then cause different amounts of reflected power to be detected at the RF charging system (and within different power-transfer zones thereof), thereby allowing the receiver to convey data to the RF charging system. Such systems and methods could further manage power transfer control communication between the RF charging system and wireless power receivers without any data-communication capability and without using any sophisticated sensors.

In the description that follows, references are made to an RF charging system that includes various antenna zones. For the purposes of this description, power-transfer (or antenna) zones include one or more power-transferring elements (e.g., antennas such as a capacitive coupler) of the RF charging system, and each power-transfer zone may be individually addressable by a controlling integrated circuit (e.g., RF power transmitter integrated circuit 160, FIGS. 1A-1B) to allow for selective activation of each power-transfer zone in order to determine which power-transfer zone is able to most efficiently transfer wireless power to a receiver. The system described herein can be used for near-field wireless charging (e.g., charging pads). For purposes of this disclosure, near-field wireless charging is the transmission of power over a distance of between 0 to 6 inches away from a wireless power transmitter. The techniques described herein may also be used for transmission of wireless power over longer distances.

(A1) In some embodiments, a method of detecting and classifying foreign objects is performed at a computer system. The computer system has one or more processors and memory storing one or more programs configured for execution by the one or more processors. The method includes obtaining a plurality of electrical measurements while a wireless-power-transmitting antenna is transmitting different power beacons. The method also includes forming a feature vector according to the plurality of electrical measurements. The method further includes detecting a presence of one or more foreign objects prior to transmitting wireless power to one or more wireless power receivers by inputting the feature vector to trained one or more classifiers. Each classifier is a machine-learning model trained to detect foreign objects distinct from the one or more wireless power receivers.

(A2) In some embodiments of the method of A1, each classifier is further trained to classify foreign objects, and the method further includes classifying the one or more foreign objects into one or more categories.

(A3) In some embodiments of the method of any one of A1-A2, at least one respective power beacon of the different power beacons. Each zone corresponds to a distinct charging area. In some embodiments, each zone has an associated transmitting antenna, and all of the zones form a wireless-power-transmission system. Each of the transmitting antennas is responsible for sending power to a respective distinct charging area. The method includes obtaining a respective set of electrical measurements for each zone of the plurality of zones. The method also includes forming the feature vector comprises calculating a respective feature data for each set of electrical measurements, and aggregating each feature data to obtain the feature vector.

(A4) In some embodiments of the method of any one of A1-A3, the method further includes, prior to inputting the feature vector to the trained one or more classifiers, transforming the feature vector to compensate for a predetermined set of conditions including environmental differences between when training the one or more classifiers to detect foreign objects and when operating the one or more classifiers to detect foreign objects (e.g., temperature, or board-to-board variation).

(A5) In some embodiments of the method of any one of A1-A4, the method further includes, applying, at a first classifier of the one or more classifiers that has a first machine-learning model, reinforcement learning to adjust (or recalibrate) one or more weights used in the first machine-learning model upon determining that (i) the first classifier has detected a presence of the one or more foreign objects and (ii) wireless power received by the one or more wireless power receivers indicates that no foreign object is present.

(A6) In some embodiments of the method of any one of A1-A5, the trained one or more classifiers detect that the one or more foreign objects are present. The method further includes continuing to (i) obtain the plurality of electrical measurements, (ii) form the feature vector, and (iii) detect that the one or more foreign objects are present by inputting the feature vector to the trained one or more classifiers. The method further includes waiting to transmit wireless power to the one or more wireless power receivers until the one or more classifiers stop detecting that the one or more foreign objects are present.

(A7) In some embodiments of the method of A6, each of the different power beacons is transmitted in an iterative fashion at each of a plurality of zones. Each zone corresponds to a distinct charging area of the wireless power transmitting antenna. The method includes obtaining a first set of electrical measurements for a first zone of the plurality of zones. The method also includes waiting to transmit wireless power to the one or more wireless power receivers until the one or more classifiers stop detecting that the one or more foreign objects are present in the first zone.

(A8) In some embodiments of the method of A6, the plurality of electrical measurements are obtained at predetermined time intervals.

(A9) In some embodiments of the method of any one of A1-A8, the plurality of electrical measurements include measurements of one or more of: load impedance, reflective power, forward power, drive current, drive voltage, magnetics, and temperature.

(A10) In some embodiments of the method of any one of A1-A9, each classifier is trained to detect one or more of: coins, credit cards, and RFID tags.

(A11) In some embodiments of the method of any one of A1-A10, the one or more classifiers are further trained to detect a presence of a first wireless power receiver. The method further includes transmitting wireless power to the first wireless power receiver. The method also includes, while transmitting the wireless power to the first wireless power receiver, continuing to (i) obtain the plurality of electrical measurements, (ii) form the feature vector, and (iii) detect that the first wireless power receiver is present by inputting the feature vector to the trained one or more classifiers. The method also includes ceasing to transmit wireless power from the wireless power transmitting antenna to the first wireless power receiver when the one or more classifiers stop detecting the presence of the first wireless power receiver.

(A12) In some embodiments of the method of any one of A1-A11, the one or more classifiers are further trained to detect a charging state of a first wireless power receiver. The method further includes transmitting wireless power to the first wireless power receiver. The method also includes, while transmitting the wireless power to the first wireless power receiver, continuing to (i) obtain the plurality of electrical measurements, (ii) form the feature vector, and (iii) detect the charging state of the first wireless power receiver by inputting the feature vector to the trained one or more classifiers. The method also includes ceasing to transmit wireless power from the wireless power transmitting antenna to the first wireless power receiver when the one or more classifiers detect that the charging state of the first wireless power receiver has reached a predetermined threshold.

(A13) In some embodiments of the method of any one of A1-A12, each power beacon of the different power beacons is transmitted as a low power burst (e.g., an electromagnetic signal that has 50% of a power level used for transmission of wireless power to a receiving device) for a short period of time (e.g., lasts for less than 1 second, as compared to transmitting higher-power signals for minutes at a time while transmitting wireless power to a receiving device).

(A14) In some embodiments of the method of any one of A1-A13, each power beacon of the different power beacons is transmitted using transmission parameters selected from a predetermined set of transmission parameters specifying at least a power level and a frequency.

(A15) In some embodiments of the method of any one of A1-A14, the one or more classifiers include a K-means classifier trained to detect the one or more wireless power receivers and to distinguish the one or more wireless power receivers from the one or more foreign objects.

(A16) In some embodiments of the method of any one of A1-A15, the one or more classifiers include a k-nearest neighbor (k-NN) classifier trained to classify the one or more wireless power receivers and the one or more foreign objects into at least one category of a plurality of categories of objects.

(A17) In some embodiments of the method of any one of A1-A16, the wireless-power-transmitting antenna is one of a plurality of wireless-power transmitting antennas. Each wireless-power-transmitting antenna associated with a respective charging area. Each classifier of the one or more classifiers is trained to detect presence of the one or more foreign objects only in a respective charging area. The method includes detecting the presence of the one or more foreign objects by inputting a respective subset of features of the feature vector corresponding to a respective charging area to a respective classifier of the one or more classifiers that is trained to detect foreign objects in the respective charging area.

(A18) In some embodiments of the method of any one of A1-A17, each classifier of the one or more classifiers is trained to detect a respective class of foreign objects. The method includes detecting the presence of the one or more foreign objects by inputting the feature vector to each classifier to detect the presence of each class of foreign objects. In some embodiments, the one or more classifiers is further trained to detect a presence of foreign objects between the wireless power transmitting antenna and a first wireless power receiver. The method further includes continuing to obtain the plurality of electrical measurements to form the feature vectors to detect the presence of the first foreign objects between the wireless power transmitting antenna and the first wireless power receiver. The method also includes ceasing to transmit wireless power from the wireless power transmitting antenna to the first wireless power receiver until the one or more classifiers stop detecting the presence of the one or more foreign objects.

(A19) In some embodiments of the method of any one of A1-A18, the wireless power transmitting antenna is configured to match the load impedance of the one or more wireless power receivers for optimal power transfer.

(A20) In some embodiments of the method of any one of A1-A19, the wireless-power-transmitting antenna is a near-field transmitting antenna.

(A21) In some embodiments of the method of A20, the near-field transmitting antenna is configured to transmit at a center frequency of between 30-50 MHz.

(A22) In some embodiments of the method of A21, the near-field transmitting antenna is further configured to transmit at a sufficient power level to deliver 20 watts of usable power to the receiver. 20 watts is a high power delivery range beyond current capabilities of inductive-based charging techniques.

(A23) In some embodiments of the method of any one of A1-A22, the one or more classifiers are trained to detect foreign objects according to a set of features that show the most correlation to change in impedance.

In another aspect, an electronic device is provided. The electronic device includes one or more processors, and memory storing one or more programs for execution by the one or more processors. The one or more programs include instructions for performing or causing performance of the method of any one of (A1)-(A23).

In another aspect, a non-transitory computer-readable storage medium stores one or more programs for execution by one or more processors of an electronic device. The one or more programs including instructions for performing or causing performance of the method of any one of (A1)-(A23).

Thus, wireless charging systems configured in accordance with the principles described herein are able to perform one or more operations including (1) alerting a user about improper placement of receiver objects or obstruction of power transmitted to authorized wireless power receivers, (2) detecting presence of any foreign object between the transmission system and the wireless power receivers, and/or (3) managing power transfer between the wireless power transmission system and wireless power receivers, thereby providing numerous improvements and resolving numerous problems and limitations of conventional wireless power transmission systems.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and not intended to circumscribe or limit the inventive subject matter.

### BRIEF DESCRIPTION OF THE DRAWINGS

So that the present disclosure can be understood in greater detail, a more particular description may be had by reference to the features of various embodiments, some of which are illustrated in the appended drawings. The appended drawings, however, merely illustrate pertinent features of the present disclosure and are therefore not to be considered limiting, for the description may admit to other effective features.

FIG. 1A is a block diagram of an RF wireless power transmission system, in accordance with some embodiments.

FIG. 1B is a block diagram showing components of an example RF charging pad that includes an RF power transmitter integrated circuit and antenna zones, in accordance with some embodiments.

FIG. 1C is a block diagram showing components of an example RF charging pad that includes an RF power transmitter integrated circuit coupled to a switch, in accordance with some embodiments.

FIG. 2A is a block diagram illustrating an example RF charging pad, in accordance with some embodiments.

FIG. 2B is a block diagram illustrating an example receiver device, in accordance with some embodiments.

FIGS. 3A-3F illustrate an example of feature permutation for a hardware architecture, in accordance with some embodiments.

FIG. 3G illustrates an example robot gantry system used to collect data to train classifier models for detecting foreign objects, in accordance with some embodiments.

FIG. 3H illustrates a set of selected features (electrical measurements) and the results of classification by a classifier based on the selected features, in accordance with some embodiments.

FIG. 3I illustrates a set of selected features (electrical measurements) and the results of classification by another classifier based on the selected features, in accordance with some embodiments.

FIG. 4 is a sequence diagram of a machine learning-based foreign object detection system, in accordance with some embodiments.

FIG. 5 is a flow diagram showing a process of detecting foreign objects (and receivers) using trained classifiers in accordance with some embodiments.

FIG. 6A is a flow diagram showing a process of detecting a receiver by sending beacon signals periodically in accordance with some embodiments.

FIG. 6B is a flow diagram showing a process of optional training performed by a transmitter in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

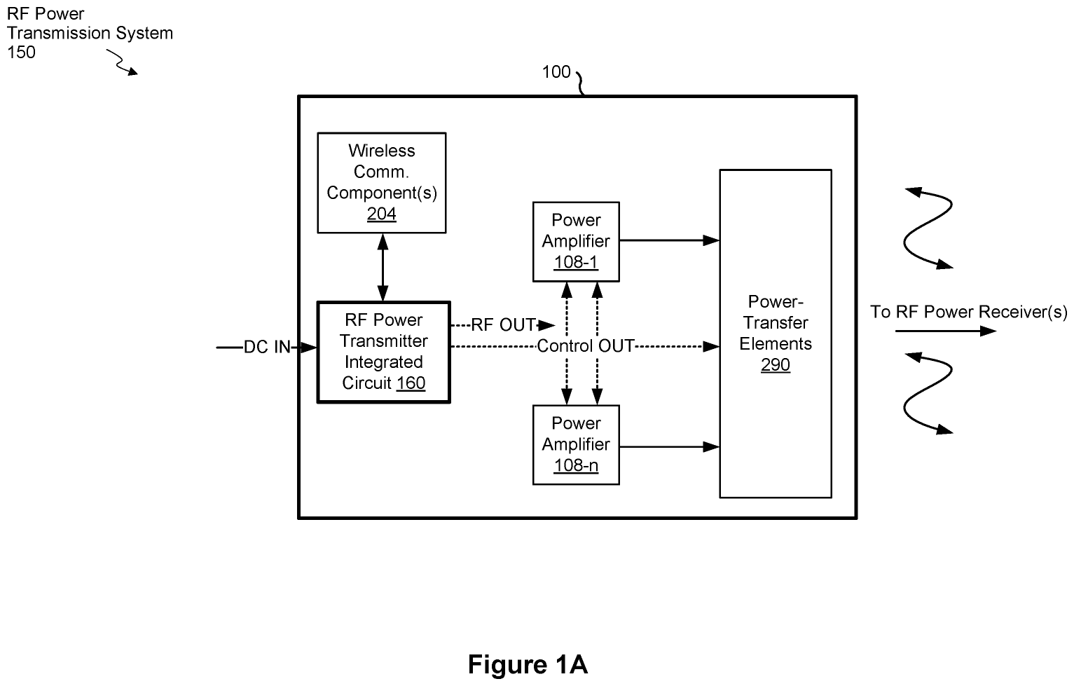

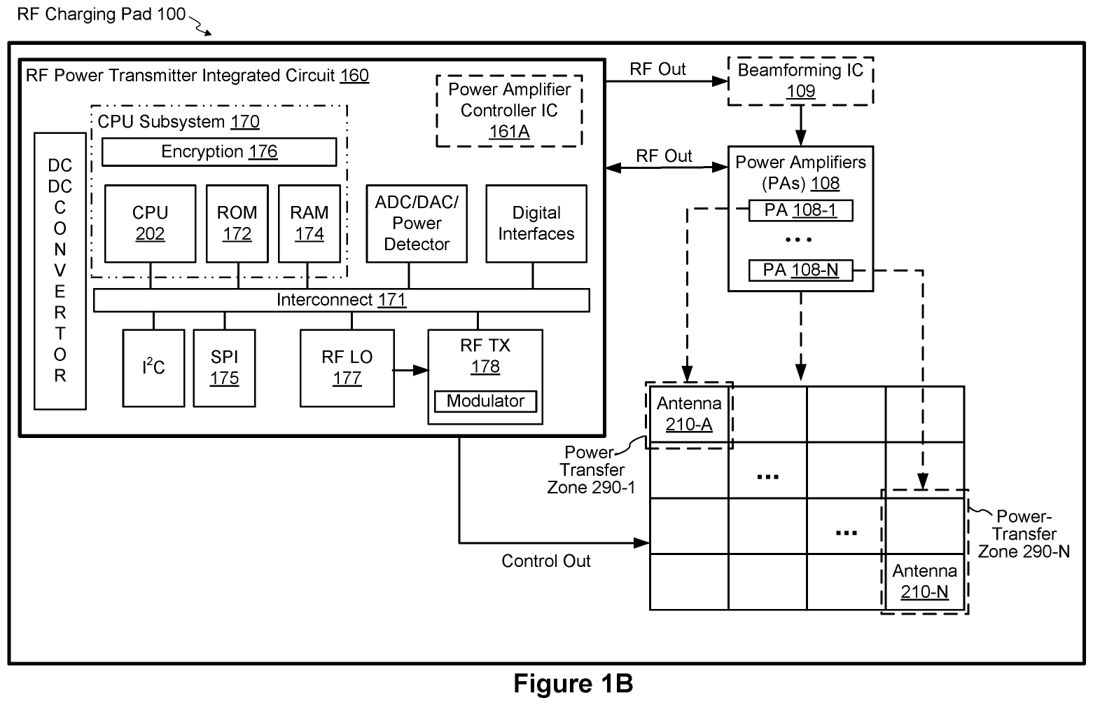

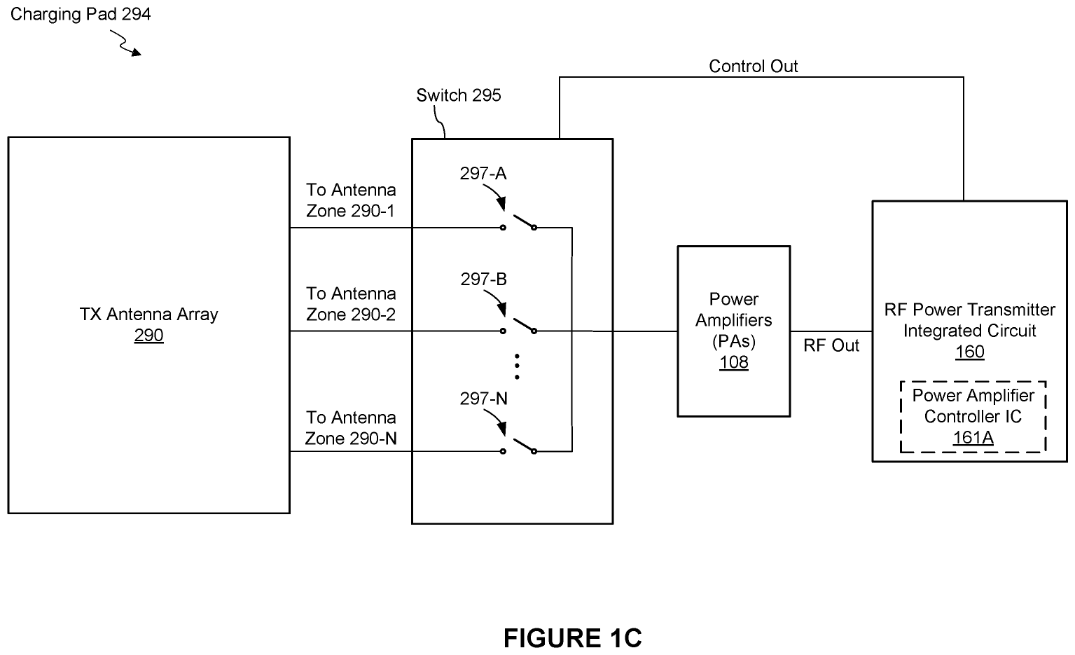

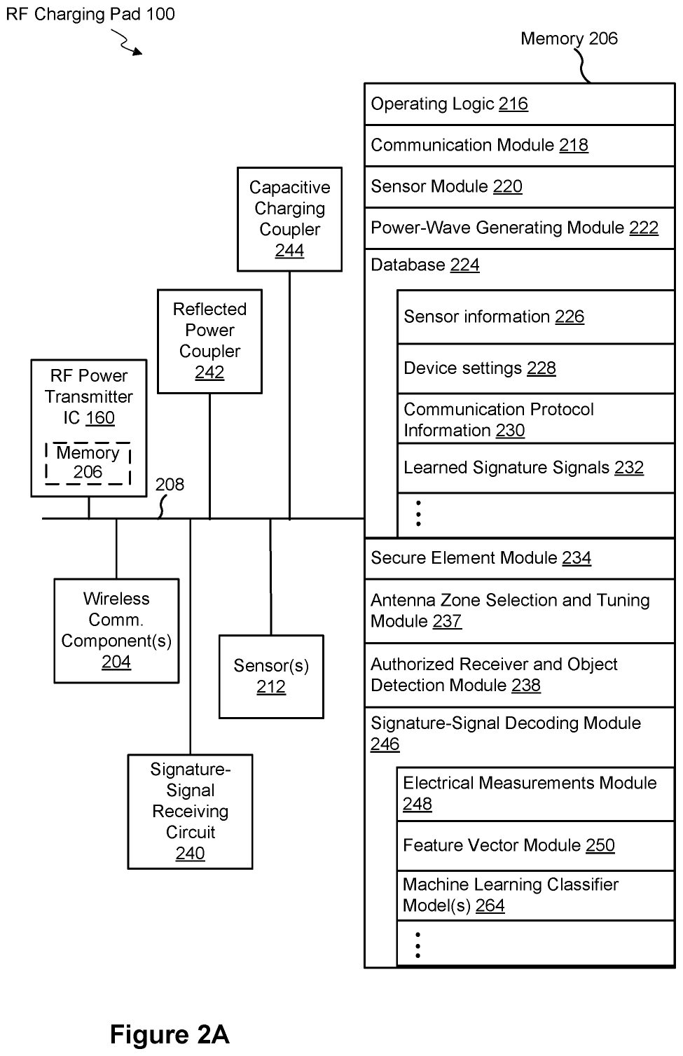

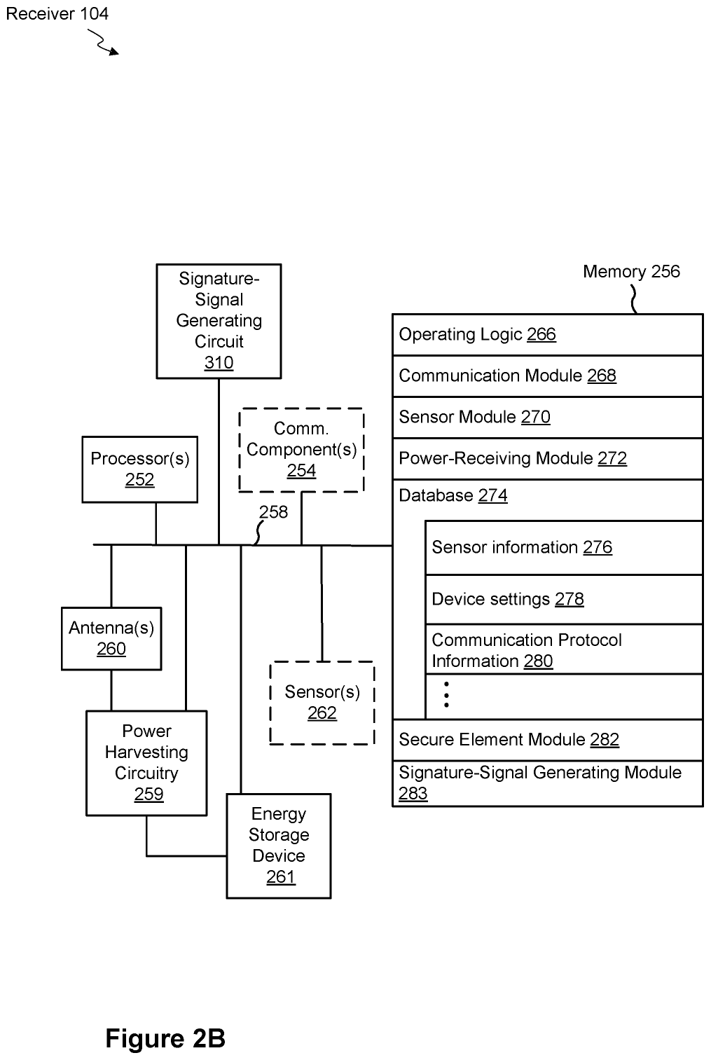

FIG. 1A is a block diagram of an RF wireless power transmission system 150 in accordance with some embodiments. In some embodiments, the RF wireless power transmission system 150 includes a far-field transmitter (not shown). In some embodiments, the RF wireless power transmission system 150 includes a RF charging pad 100 (also referred to herein as a near-field (NF) charging pad 100 or RF charging pad 100). In some embodiments, the RF charging pad 100 includes an RF power transmitter integrated circuit 160 (described in more detail below). In some embodiments, the RF charging pad 100 includes one or more communications components 204 (e.g., wireless communication components, such as WI-FI or BLUETOOTH radios), discussed in more detail below with reference to FIG. 2A. In some embodiments, the RF charging pad 100 also connects to one or more power amplifier units 108-1, . . . 108-n to control operation of the one or more power amplifier units when they drive external power-transfer elements (e.g., power-transfer elements 290). In some embodiments, RF power is controlled and modulated at the RF charging pad 100 via switch circuitry as to enable the RF wireless power transmission system to send RF power to one or more wireless receiving devices via the TX antenna array 210.

In some embodiments, the communication component(s) 204 enable communication between the RF charging pad 100 and one or more communication networks. In some embodiments, the communication component(s) 204 are capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, MiWi, etc.) custom or standard wired protocols (e.g., Ethernet, HomePlug, etc.), and/or any other suitable communication protocol, including communication protocols not yet developed as of the filing date of this document.

In some instances, the communication component(s) 204 are not able to communicate with wireless power receivers for various reasons, e.g., because there is no power available for the communication component(s) to use for the transmission of data signals or because the wireless power receiver itself does not actually include any communication component of its own. As such, it is important to design near-field charging pads that are still able to uniquely identify different types of devices and, when a wireless power receiver is detected, figure out if that wireless power receiver is authorized to receive wireless power.

FIG. 1B is a block diagram of the RF power transmitter integrated circuit 160 (the “integrated circuit”) in accordance with some embodiments. In some embodiments, the integrated circuit 160 includes a CPU subsystem 170, an external device control interface, an RF subsection for DC to RF power conversion, and analog and digital control interfaces interconnected via an interconnection component, such as a bus or interconnection fabric block 171. In some embodiments, the CPU subsystem 170 includes a microprocessor unit (CPU) 202 with related Read-Only-Memory (ROM) 172 for device program booting via a digital control interface, e.g. an I²C port, to an external FLASH containing the CPU executable code to be loaded into the CPU Subsystem Random Access Memory (RAM) 174 (e.g., memory 206, FIG. 2A) or executed directly from FLASH. In some embodiments, the CPU subsystem 170 also includes an encryption module or block 176 to authenticate and secure communication exchanges with external devices, such as wireless power receivers that attempt to receive wirelessly delivered power from the RF charging pad 100.

In some embodiments, the RF IC 160 also includes (or is in communication with) a power amplifier controller IC 161A (PA IC) that is responsible for controlling and managing operations of a power amplifier, including for reading measurements of impedance at various measurement points within the power amplifier, which measurements are used in some instances to allow for detection of foreign objects. The PA IC may be on the same integrated circuit at the RF IC 160, or may be on its on integrated circuit that is separate from (but still in communication with) the RF IC 160. Additional details regarding the architecture and operation of the PA IC are provided in U.S. Provisional Application No. 62/903,677, which disclosure is incorporated by reference in its entirety.

In some embodiments, executable instructions running on the CPU (such as those shown in the memory 206 in FIG. 2A and described below) are used to manage operation of the RF charging pad 100 and to control external devices through a control interface, e.g., SPI control interface 175, and the other analog and digital interfaces included in the RF power transmitter integrated circuit 160. In some embodiments, the CPU subsystem also manages operation of the RF subsection of the RF power transmitter integrated circuit 160, which includes an RF local oscillator (LO) 177 and an RF transmitter (TX) 178. In some embodiments, the RF LO 177 is adjusted based on instructions from the CPU subsystem 170 and is thereby set to different desired frequencies of operation, while the RF TX converts, amplifies, modulates the RF output as desired to generate a viable RF power level.

In the descriptions that follow, various references are made to antenna zones and power-transfer zones, which terms are used synonymously in this disclosure. In some embodiments the antenna/power-transfer zones may include antenna elements that transmit propagating radio frequency waves but, in other embodiments, the antenna/power transfer zones may instead include capacitive charging couplers that convey electrical signals but do not send propagating radio frequency waves.

In some embodiments, the RF power transmitter integrated circuit 160 provides the viable RF power level (e.g., via the RF TX 178) to an optional beamforming integrated circuit (IC) 109, which then provides phase-shifted signals to one or more power amplifiers 108. In some embodiments, the beamforming IC 109 is used to ensure that power transmission signals sent using two or more antennas 210 (e.g., each antenna 210 may be associated with a different antenna zone 290 or may each belong to a single antenna zone 290) to a particular wireless power receiver are transmitted with appropriate characteristics (e.g., phases) to ensure that power transmitted to the particular wireless power receiver is maximized (e.g., the power transmission signals arrive in phase at the particular wireless power receiver). In some embodiments, the beamforming IC 109 forms part of the RF power transmitter IC 160. In embodiments in which capacitive couplers (e.g., capacitive charging couplers 244) are used as the antennas 210, then optional beamforming IC 109 may not be included in the RF power transmitter integrated circuit 160.

In some embodiments, the RF power transmitter integrated circuit 160 provides the viable RF power level (e.g., via the RF TX 178) directly to the one or more power amplifiers 108 and does not use the beamforming IC 109 (or bypasses the beamforming IC if phase-shifting is not required, such as when only a single antenna 210 is used to transmit power transmission signals to a wireless power receiver). In some embodiments, the PA IC 161A receives the viable RF power level and provides that to the PAs 108.

In some embodiments, the one or more power amplifiers 108 then provide RF signals to the antenna zones 290 (also referred to herein as “power-transfer zones”) for transmission to wireless power receivers that are authorized to receive wirelessly delivered power from the RF charging pad 100. In some embodiments, each antenna zone 290 is coupled with a respective PA 108 (e.g., antenna zone 290-1 is coupled with PA 108-1 and antenna zone 290-N is coupled with PA 108-N). In some embodiments, multiple antenna zones are each coupled with a same set of PAs 108 (e.g., all PAs 108 are coupled with each antenna zone 290). Various arrangements and couplings of PAs 108 to antenna zones 290 allow the RF charging pad 100 to sequentially or selectively activate different antenna zones in order to determine the most efficient antenna zone 290 to use for transmitting wireless power to a wireless power receiver. In some embodiments, the one or more power amplifiers 108 are also in communication with the CPU subsystem 170 to allow the CPU 202 to measure output power provided by the PAs 108 to the antenna zones of the RF charging pad 100. In some embodiments, the PAs 108 may include various measurement points that allow for at least measuring impedance values that are used to enable the foreign object detection techniques described herein (additional details and examples regarding such measurement points are provided in the incorporated-by-reference U.S. Provisional Application No. 62/903,677.

FIG. 1B also shows that, in some embodiments, the antenna zones 290 of the RF charging pad 100 may include one or more antennas 210A-N. In some embodiments, each antenna zones of the plurality of antenna zones includes one or more antennas 210 (e.g., antenna zone 290-1 includes one antenna 210-A and antenna zones 290-N includes multiple antennas 210). In some embodiments, a number of antennas included in each of the antenna zones is dynamically defined based on various parameters, such as a location of a wireless power receiver on the RF charging pad 100. In some embodiments, the antenna zones may include one or more of the meandering line antennas described in more detail below. In some embodiments, each antenna zone 290 may include antennas of different types (e.g., a meandering line antenna and a loop antenna), while in other embodiments each antenna zone 290 may include a single antenna of a same type (e.g., all antenna zones 290 include one meandering line antenna), while in still other embodiments, the antennas zones may include some antenna zones that include a single antenna of a same type and some antenna zones that include antennas of different types. In some embodiments the antenna/power-transfer zones may also or alternatively include capacitive charging couplers that convey electrical signals but do not send propagating radio frequency waves. Antenna zones are also described in further detail below.

In some embodiments, the RF charging pad 100 may also include a temperature monitoring circuit that is in communication with the CPU subsystem 170 to ensure that the RF charging pad 100 remains within an acceptable temperature range. For example, if a determination is made that the RF charging pad 100 has reached a threshold temperature, then operation of the RF charging pad 100 may be temporarily suspended until the RF charging pad 100 falls below the threshold temperature.

By including the components shown for RF power transmitter circuit 160 (FIG. 1B) on a single chip, such transmitter chips are able to manage operations at the transmitter chips more efficiently and quickly (and with lower latency), thereby helping to improve user satisfaction with the charging pads that are managed by these transmitter chips. For example, the RF power transmitter circuit 160 is cheaper to construct, has a smaller physical footprint, and is simpler to install. Furthermore, and as explained in more detail below in reference to FIG. 2A, the RF power transmitter circuit 160 may also include a secure element module 234 (e.g., included in the encryption block 176 shown in FIG. 1B) that is used in conjunction with a secure element module 282 (FIG. 2B) or a receiver 104 to ensure that only authorized receivers are able to receive wirelessly delivered power from the RF charging pad 100 (FIG. 1B).

FIG. 1C is a block diagram of a charging pad 294 in accordance with some embodiments. The charging pad 294 is an example of the charging pad 100 (FIG. 1A), however, one or more components included in the charging pad 100 are not included in the charging pad 294 for ease of discussion and illustration.

The charging pad 294 includes an RF power transmitter integrated circuit 160, one or more power amplifiers 108, a PA IC 161A (which may be on the same or a separate IC from the RF power transmitter IC 160), and a transmitter antenna array 290 having multiple antenna zones. Each of these components is described in detail above with reference to FIGS. 1A and 1B. Additionally, the charging pad 294 includes a switch 295 (i.e., transmitter-side switch), positioned between the power amplifiers 108 and the antenna array 290, having a plurality of switches 297-A, 297-B, . . . 297-N. The switch 295 is configured to switchably connect one or more power amplifiers 108 with one or more antenna zones of the antenna array 290 in response to control signals provided by the RF power transmitter integrated circuit 160.

To accomplish the above, each switch 297 is coupled with (e.g., provides a signal pathway to) a different antenna zone of the antenna array 290. For example, switch 297-A may be coupled with a first antenna zone 290-1 (FIG. 1B) of the antenna array 290, switch 297-B may be coupled with a second antenna zone 290-2 of the antenna array 290, and so on. Each of the plurality of switches 297-A, 297-B, . . . 297-N, once closed, creates a unique pathway between a respective power amplifier 108 (or multiple power amplifiers 108) and a respective antenna zone of the antenna array 290. Each unique pathway through the switch 295 is used to selectively provide RF signals to specific antenna zones of the antenna array 290. It is noted that two or more of the plurality of switches 297-A, 297-B, . . . 297-N may be closed at the same time, thereby creating multiple unique pathways to the antenna array 290 that may be used simultaneously.

In some embodiments, the RF power transmitter integrated circuit 160 (or the PA IC 161A, or both) is (are) coupled to the switch 295 and is configured to control operation of the plurality of switches 297-A, 297-B, . . . 297-N (illustrated as a “control out” signal in FIGS. 1A and 1C). For example, the RF power transmitter integrated circuit 160 may close a first switch 297-A while keeping the other switches open. In another example, the RF power transmitter integrated circuit 160 may close a first switch 297-A and a second switch 297-B, and keep the other switches open (various other combinations and configuration are possible). Moreover, the RF power transmitter integrated circuit 160 is coupled to the one or more power amplifiers 108 and is configured to generate a suitable RF signal (e.g., the “RF Out” signal) and provide the RF signal to the one or more power amplifiers 108. The one or more power amplifiers 108, in turn, are configured to provide the RF signal to one or more antenna zones of the antenna array 290 via the switch 295, depending on which switches 297 in the switch 295 are closed by the RF power transmitter integrated circuit 160.

To further illustrate, as described in some embodiments below, the charging pad is configured to transmit test power transmission signals and/or regular power transmission signals using different antenna zones, e.g., depending on a location of a receiver on the charging pad. Accordingly, when a particular antenna zone is selected for transmitting test signals or regular power signals, a control signal is sent to the switch 295 from the RF power transmitter integrated circuit 160 to cause at least one switch 297 to close. In doing so, an RF signal from at least one power amplifier 108 can be provided to the particular antenna zone using a unique pathway created by the now-closed at least one switch 297.

In some embodiments, the switch 295 may be part of (e.g., internal to) the antenna array 290. Alternatively, in some embodiments, the switch 295 is separate from the antenna array 290 (e.g., the switch 295 may be a distinct component, or may be part of another component, such as the power amplifier(s) 108). It is noted that any switch design capable of accomplishing the above may be used, and the design of the switch 295 illustrated in FIG. 1C is merely one example.

FIG. 2A is a block diagram illustrating certain components of an RF charging pad 100 in accordance with some embodiments. In some embodiments, the RF charging pad 100 includes an RF power transmitter IC 160 (and the components included therein, such as those described above in reference to FIGS. 1A-1B), memory 206 (which may be included as part of the RF power transmitter IC 160, such as nonvolatile memory 206 that is part of the CPU subsystem 170), and one or more communication buses 208 for interconnecting these components (sometimes called a chipset). In some embodiments, the RF charging pad 100 includes one or more sensor(s) 212 (discussed below). In some embodiments, the RF charging pad 100 includes one or more output devices such as one or more indicator lights, a sound card, a speaker, a small display for displaying textual information and error codes, etc. In some embodiments, the RF charging pad 100 includes a location detection device, such as a GPS (global positioning satellite) or other geo-location receiver, for determining the location of the RF charging pad 100.

In some embodiments, the one or more sensor(s) 212 include one or more thermal radiation sensors, ambient temperature sensors, humidity sensors, IR sensors, occupancy sensors (e.g., RFID sensors), ambient light sensors, motion detectors, accelerometers, and/or gyroscopes.

In some embodiments, the RF charging pad 100 further includes a signature-signal receiving circuit 240, a reflected power coupler 242, and a capacitive charging coupler 244.

The memory 206 includes high-speed random access memory, such as DRAM, SRAM, DDR SRAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 206, or alternatively the non-volatile memory within memory 206, includes a non-transitory computer-readable storage medium. In some embodiments, the memory 206, or the non-transitory computer-readable storage medium of the memory 206, stores the following programs, modules, and data structures, or a subset or superset thereof:
Operating logic 216 including procedures for handling various basic system services and for performing hardware dependent tasks;
Communication module 218 for coupling to and/or communicating with remote devices (e.g., remote sensors, transmitters, receivers, servers, mapping memories, etc.) in conjunction with wireless communication component(s) 204;
Sensor module 220 for obtaining and processing sensor data (e.g., in conjunction with sensor(s) 212) to, for example, determine the presence, velocity, and/or positioning of object in the vicinity of the RF charging pad 100;
Power-wave generating module 222 for generating and transmitting power transmission signals (e.g., in conjunction with antenna zones 290 and the antennas 210 respectively included therein), including but not limited to, forming pocket(s) of energy at given locations. Power-wave generating module 222 may also be used to modify values of transmission characteristics (e.g., power level (i.e., amplitude), phase, frequency, etc.) used to transmit power transmission signals by individual antenna zones;
Database 224, including but not limited to:
   Sensor information 226 for storing and managing data received, detected, and/or transmitted by one or more sensors (e.g., sensors 212 and/or one or more remote sensors);
   Device settings 228 for storing operational settings for the RF charging pad 100 and/or one or more remote devices;
   Communication protocol information 230 for storing and managing protocol information for one or more protocols (e.g., custom or standard wireless protocols, such as ZigBee, Z-Wave, etc., and/or custom or standard wired protocols, such as Ethernet); and
   Learned signature signals 232 for a variety of different wireless power receivers and other objects (which are not wireless power receivers).
a secure element module 234 for determining whether a wireless power receiver is authorized to receive wirelessly delivered power from the RF charging pad 100;
an antenna zone selecting and tuning module 237 for coordinating a process of transmitting test power transmission signals with various antenna zones to determine which antenna zone or zones should be used to wirelessly deliver power to various wireless power receivers (as is explained in more detail below in reference to FIGS. 9A-9B of incorporated-by-reference PCT Patent Application No. PCT/US17/65886);
an authorized receiver and object detection module 238 used for detecting various signature signals from wireless power receivers and from other objects, and then determining appropriate actions based on the detecting of the various signature signals (as is described in more detail below in reference to FIGS. 9A-9B); and
a signature-signal decoding module 246 used to decode the detected signature signals and determine message or data content. In some embodiments, the module 246 includes an electrical measurement module 248 to collect electrical measurements from one or more receivers (e.g., in response to power beacon signals), a feature vector module 250 to compute feature vectors based on the electrical measurements collected by the electrical measurement module 246, and/or machine learning classifier model(s) 264 that are trained to detect and/or classify foreign objects.

Each of the above-identified elements (e.g., modules stored in memory 206 of the RF charging pad 100) is optionally stored in one or more of the previously mentioned memory devices, and corresponds to a set of instructions for performing the function(s) described above. The above-identified modules or programs (e.g., sets of instructions) need not be implemented as separate software programs, procedures, or modules, and thus various subsets of these modules are optionally combined or otherwise rearranged in various embodiments. In some embodiments, the memory 206, optionally, stores a subset of the modules and data structures identified above.

FIG. 2B is a block diagram illustrating a representative receiver device 104 (also sometimes called a receiver, power receiver, or wireless power receiver) in accordance with some embodiments. In some embodiments, the receiver device 104 includes one or more processing units (e.g., CPUs, ASICs, FPGAs, microprocessors, and the like) 252, one or more communication components 254, memory 256, antenna(s) 260, power harvesting circuitry 259, and one or more communication buses 258 for interconnecting these components (sometimes called a chipset). In some embodiments, the receiver device 104 includes one or more sensor(s) 262 such as the one or sensors 212 described above with reference to FIG. 2A. In some embodiments, the receiver device 104 includes an energy storage device 261 for storing energy harvested via the power harvesting circuitry 259. In various embodiments, the energy storage device 261 includes one or more batteries, one or more capacitors, one or more inductors, and the like.

In some embodiments, the power harvesting circuitry 259 includes one or more rectifying circuits and/or one or more power converters. In some embodiments, the power harvesting circuitry 259 includes one or more components (e.g., a power converter) configured to convert energy from power waves and/or energy pockets to electrical energy (e.g., electricity). In some embodiments, the power harvesting circuitry 259 is further configured to supply power to a coupled electronic device, such as a laptop or phone. In some embodiments, supplying power to a coupled electronic device include translating electrical energy from an AC form to a DC form (e.g., usable by the electronic device).

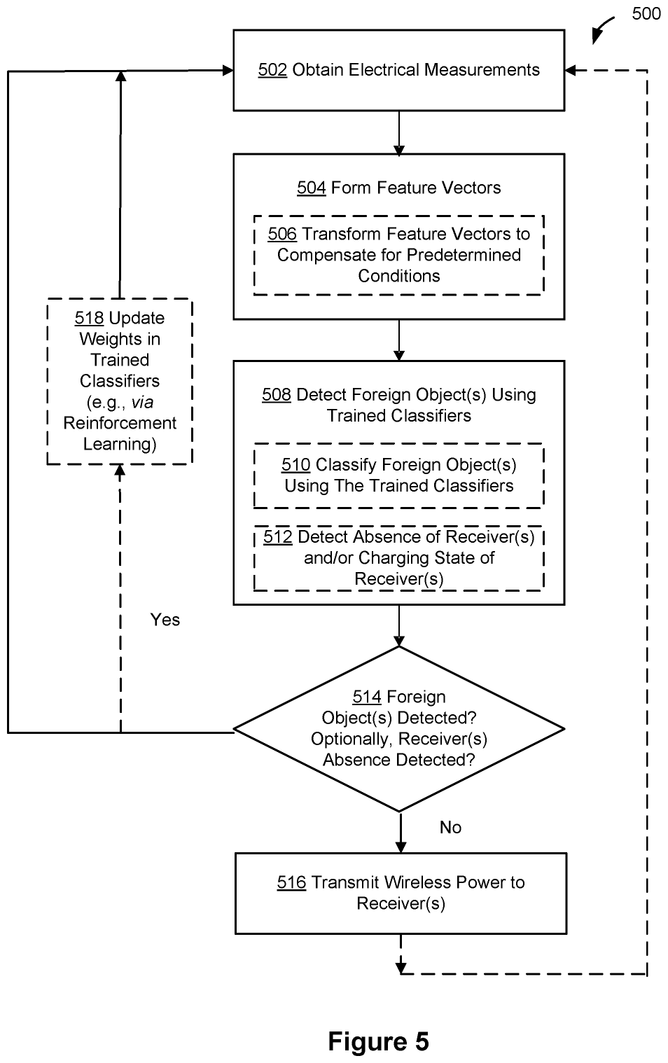

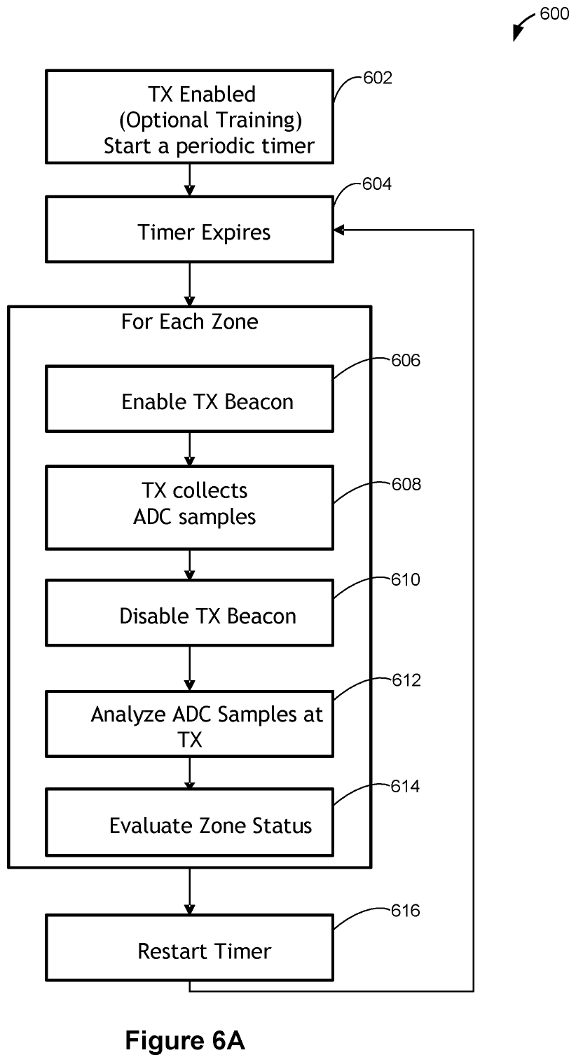

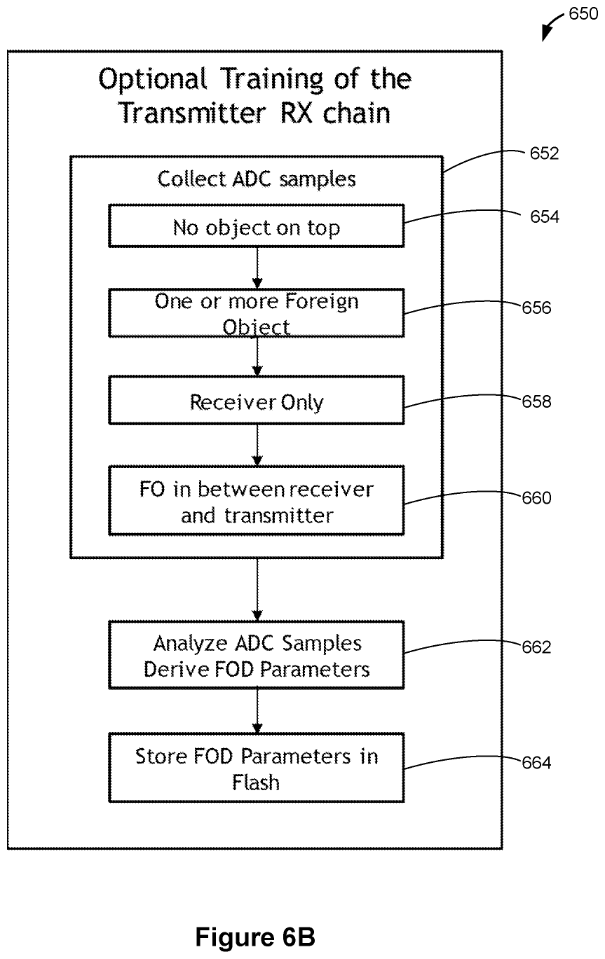

In some embodiments, the antenna(s) 260 include one or more of the meandering line antennas that are described in further detail in incorporated-by-reference PCT Patent Application No. PCT/US17/65886 (e.g., with reference to FIGS. 6A-7D, and elsewhere). In some embodiments, the antenna(s) 260 may also or alternatively include capacitive charging couplers (such as those described with reference to FIGS. 5A-5B of incorporated-by-reference U.S. patent application Ser. No. 16/045,637) that correspond in structure to those that may be present in a near-field charging pad.

In some embodiments, the receiver device 104 includes one or more output devices such as one or more indicator lights, a sound card, a speaker, a small display for displaying textual information and error codes, etc. In some embodiments, the receiver device 104 includes a location detection device, such as a GPS (global positioning satellite) or other geo-location receiver, for determining the location of the receiver device 103.

In various embodiments, the one or more sensor(s) 262 include one or more thermal radiation sensors, ambient temperature sensors, humidity sensors, IR sensors, occupancy sensors (e.g., RFID sensors), ambient light sensors, motion detectors, accelerometers, and/or gyroscopes. It is noted that the foreign object detection techniques disclosed herein operate without relying on the one or more sensor(s) 262.

The communication component(s) 254 enable communication between the receiver 104 and one or more communication networks. In some embodiments, the communication component(s) 254 are capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, MiWi, etc.) custom or standard wired protocols (e.g., Ethernet, HomePlug, etc.), and/or any other suitable communication protocol, including communication protocols not yet developed as of the filing date of this document. It is noted that the foreign object detection techniques disclosed herein operate without relying on the communication component(s) 254.

The communication component(s) 254 include, for example, hardware capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, MiWi, etc.) and/or any of a variety of custom or standard wired protocols (e.g., Ethernet, HomePlug, etc.), or any other suitable communication protocol, including communication protocols not yet developed as of the filing date of this document.

The memory 256 includes high-speed random access memory, such as DRAM, SRAM, DDR SRAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 256, or alternatively the non-volatile memory within memory 256, includes a non-transitory computer-readable storage medium. In some embodiments, the memory 256, or the non-transitory computer-readable storage medium of the memory 256, stores the following programs, modules, and data structures, or a subset or superset thereof:
Operating logic 266 including procedures for handling various basic system services and for performing hardware dependent tasks;
Communication module 268 for coupling to and/or communicating with remote devices (e.g., remote sensors, transmitters, receivers, servers, mapping memories, etc.) in conjunction with communication component(s) 254;
Sensor module 270 for obtaining and processing sensor data (e.g., in conjunction with sensor(s) 262) to, for example, determine the presence, velocity, and/or positioning of the receiver 103, a RF charging pad 100, or an object in the vicinity of the receiver 103;
Wireless power-receiving module 272 for receiving (e.g., in conjunction with antenna(s) 260 and/or power harvesting circuitry 259) energy from, capacitively-conveyed electrical signals, power waves, and/or energy pockets: optionally converting (e.g., in conjunction with power harvesting circuitry 259) the energy (e.g., to direct current): transferring the energy to a coupled electronic device; and optionally storing the energy (e.g., in conjunction with energy storage device 261);
Database 274, including but not limited to:
   Sensor information 276 for storing and managing data received, detected, and/or transmitted by one or more sensors (e.g., sensors 262 and/or one or more remote sensors);
   Device settings 278 for storing operational settings for the receiver 103, a coupled electronic device, and/or one or more remote devices; and
   Communication protocol information 280 for storing and managing protocol information for one or more protocols (e.g., custom or standard wireless protocols, such as ZigBee, Z-Wave, etc., and/or custom or standard wired protocols, such as Ethernet);
a secure element module 282 for providing identification information to the RF charging pad 100 (e.g., the RF charging pad 100 uses the identification information to determine if the wireless power receiver 104 is authorized to receive wirelessly delivered power); and
a signature-signal generating module 283 used to control (e.g., in conjunction with a signature-signal generating circuit) various components to cause impedance changes at the antenna(s) 260 and/or power harvesting circuitry 259 to then cause changes in reflected power as received by a signature-signal receiving circuit 240.

Each of the above-identified elements (e.g., modules stored in memory 256 of the receiver 104) is optionally stored in one or more of the previously mentioned memory devices, and corresponds to a set of instructions for performing the function(s) described above. The above-identified modules or programs (e.g., sets of instructions) need not be implemented as separate software programs, procedures, or modules, and thus various subsets of these modules are optionally combined or otherwise rearranged in various embodiments. In some embodiments, the memory 256, optionally, stores a subset of the modules and data structures identified above. Furthermore, the memory 256, optionally, stores additional modules and data structures not described above, such as an identifying module for identifying a device type of a connected device (e.g., a device type for an electronic device that is coupled with the receiver 104).

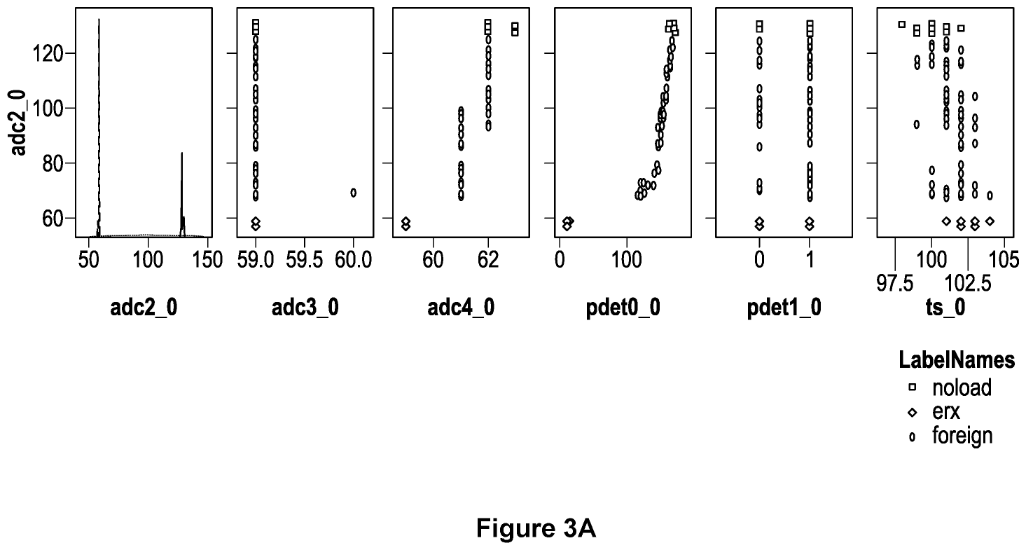

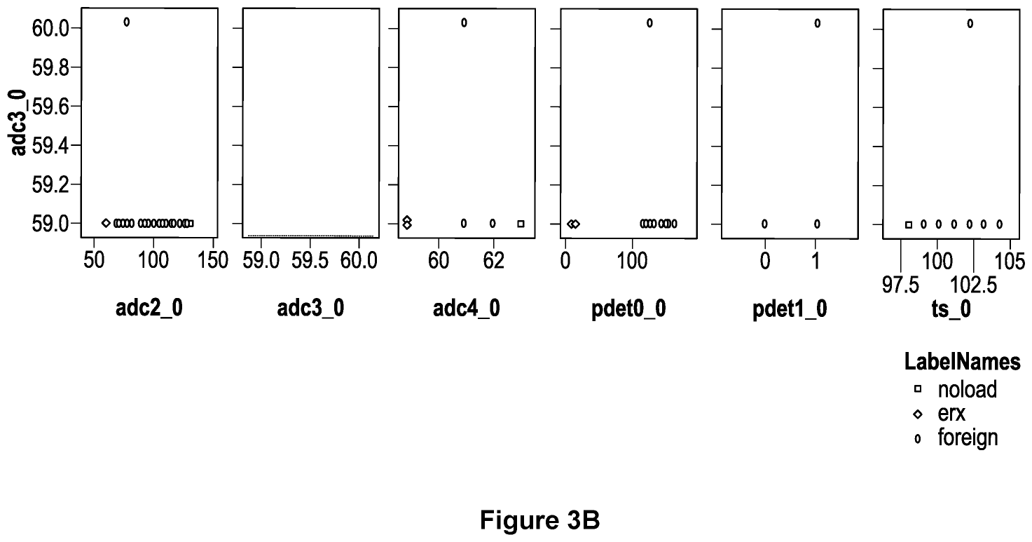

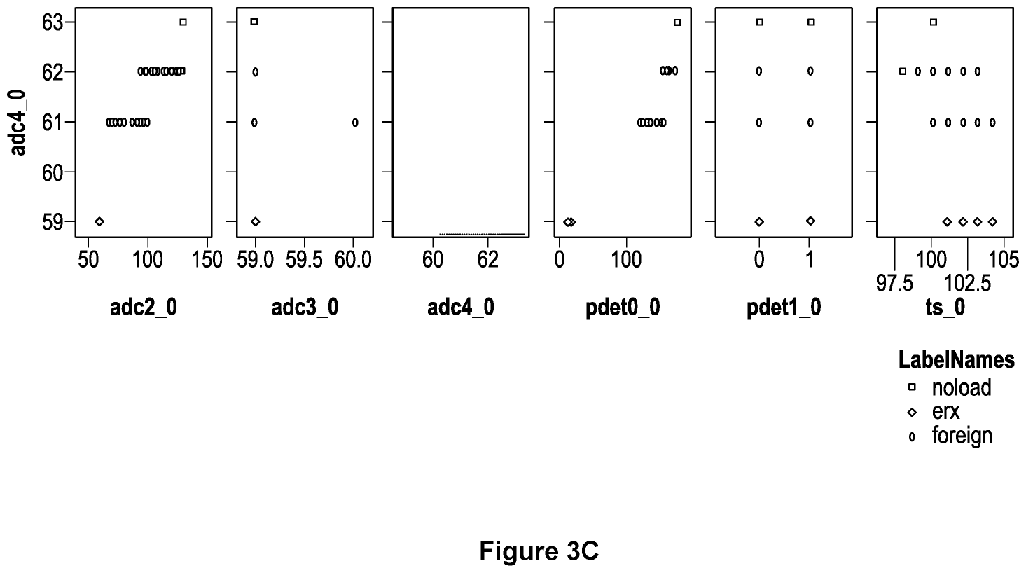

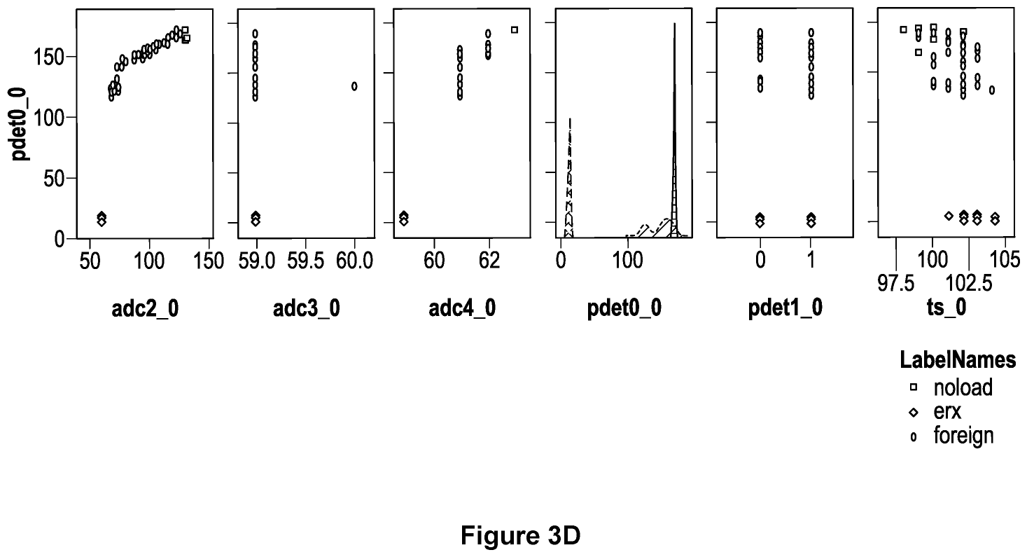

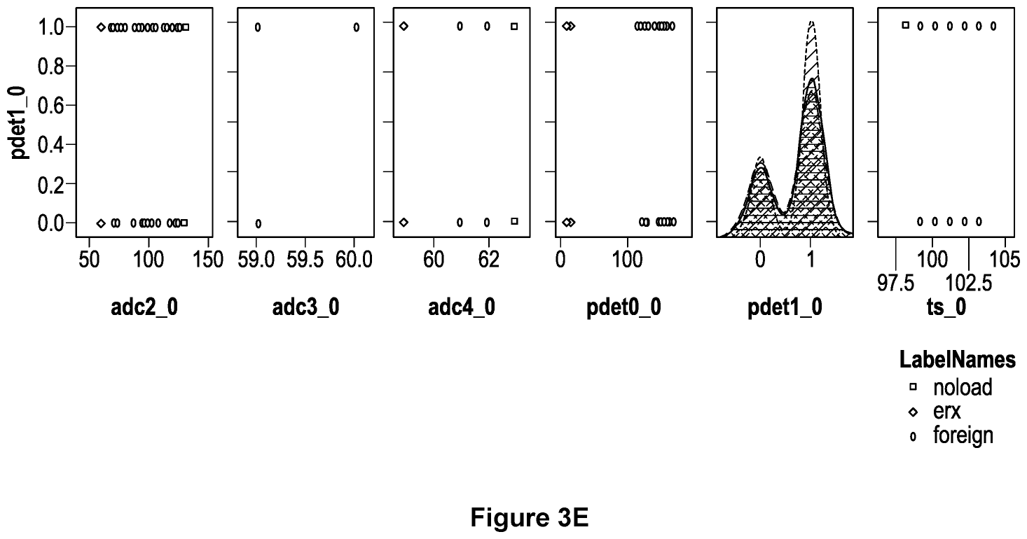

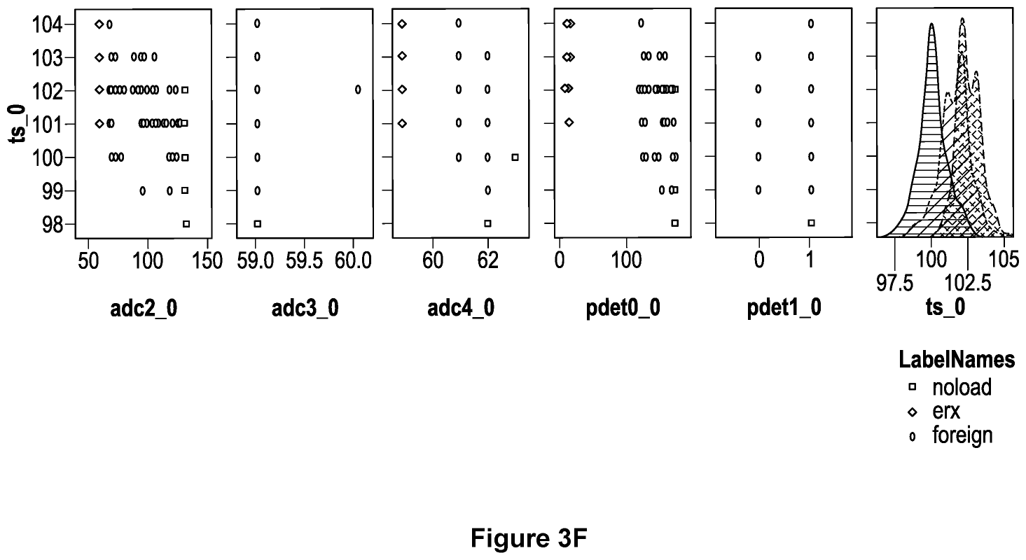

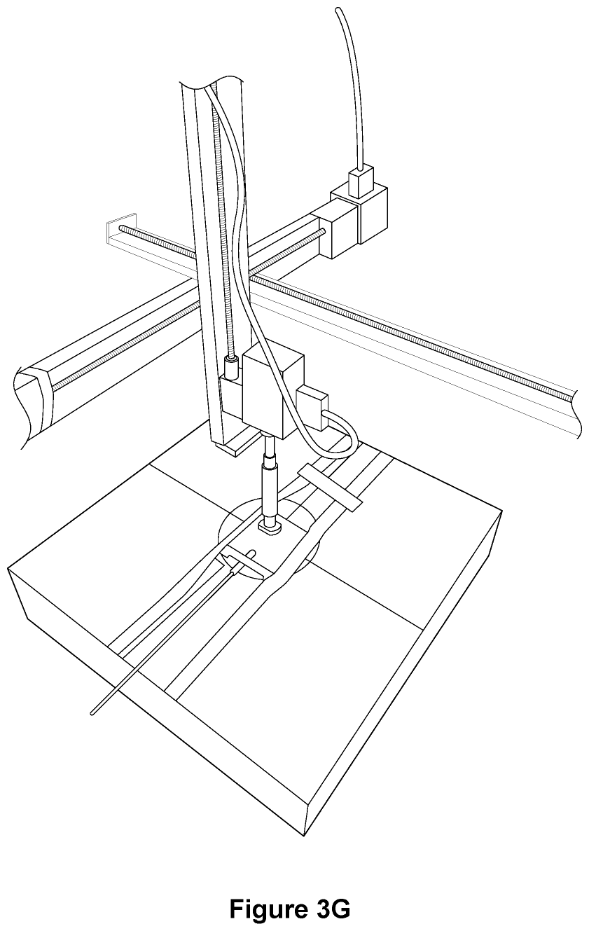

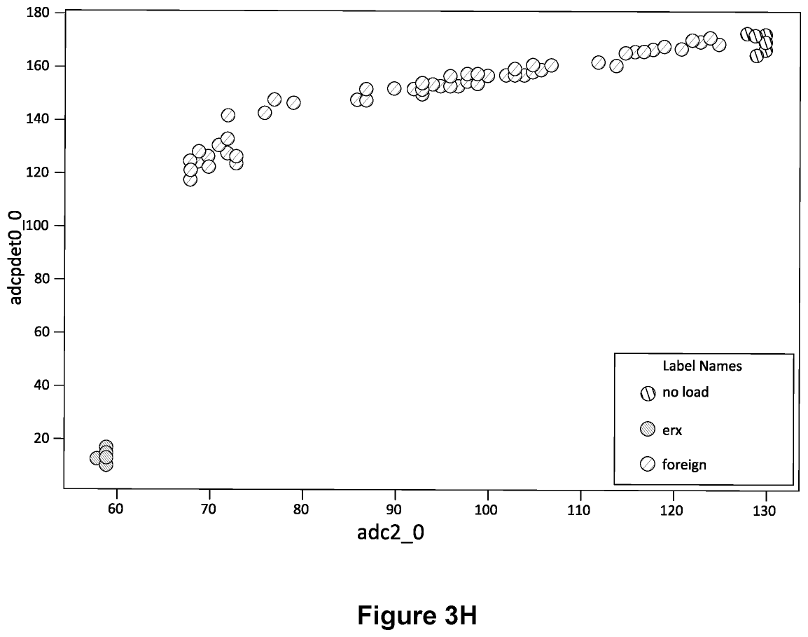

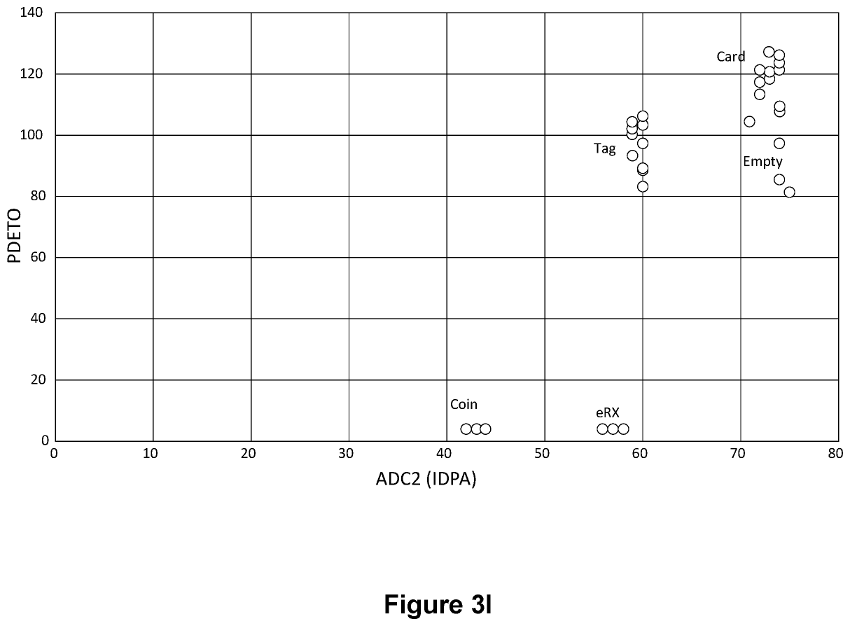

In some embodiments, the near-field charging pads disclosed herein may use adaptive loading techniques to optimize power transfer. Such techniques are described in detail in commonly-owned and incorporated-by-reference PCT Application No. PCT/US17/65886 and, in particular, in reference to FIGS. 3A-8 and 12-15.

### An Example Machine Learning Based Foreign Object Detection System

An example machine learning-based foreign object detection system (e.g., the RF charging pad 100) is described herein, according to some embodiments. The system detects and classifies foreign objects in close proximity to (e.g., less than a few centimeters or inches of) a wireless power transmission system. In some embodiments, the system detects and classifies foreign objects for a near-field wireless power transmission system that is configured to transmit wireless power over a range of distance that extends from 0) to 6 inches of a housing the houses components of the system, but may also be configured to transmit such power over a range of up to 1 meter (e.g., for mid-field transmission of power), or to a range that extends to a few feet away (e.g., for far-field transmission of power). In some embodiments, the detection system utilizes system features (e.g., load impedance or reactance, reflective power, magnetics, temperature) that are measured directly (e.g., reflective power detection) by the transmitter (e.g., by the electrical measurements module 248). In some embodiments, the detection system utilizes features that are measured indirectly (e.g. load voltage, load current) by the transmitter. The features are input to a machine learning model (e.g., the machine learning classifier models 264) to infer the classification of objects (sometimes called foreign objects: e.g., receiver, coins, credit cards, RFID tags).

In some embodiments, the classification of the objects along with the transmitter's charging policy are used to control the power transmission. The detection system identifies the objects and determines whether it is safe to transmit power to charge devices, and/or whether certain adjustments to the transmission of power are needed to ensure that safety is maintained (e.g., reducing power levels, changing directivity to avoid certain objects, etc.). In some embodiments, the detection system indicates (to a user) a presence of a foreign object that is obstructing a device. In some embodiments, the detection system indicates if the foreign objects are within close proximity (e.g., within 6 inches) of one or more charging zones. In some embodiments, the detection system detects and classifies objects within a charging zone as either a receiver, or a foreign object. In some embodiments, the detection system detects the absence (e.g., located beyond six inches) of objects in a charging zone. In some embodiments, the detection system detects objects between a receiver and a charging zone. In some embodiments, the detection system detects position of a receiver in a charging zone. In some embodiments, the detection system detects a charging state of a receiver in a charging zone. In some embodiments, the detection system detects and classifies objects in multiple charging zones. In some embodiments, the detection system determines a charging policy with respect to valid objects (e.g., receiver and business cards).

In some embodiments, the detection system uses self-calibration to adjust for temperature and/or wireless power hardware variations. In some embodiments, the detection system is calibrated during manufacturing for environmental conditions (e.g., board to board variations). In some embodiments, the detection system is calibrated for variations in components' tolerances. In some embodiments, the detection system is calibrated for manufacturing variability in antenna thickness, dielectric, etc. Such variations result in offsets or shifts of feature vector clustering. In some embodiments, calibration with reference objects, at the time of manufacturing (e.g., in a factory setting) is used to cancel out the offsets. In some embodiments, the calibration parameters are stored in non-volatile memory of the calibrated device.

In some embodiments, the detection system incorporates auto-calibration for fault tolerance (e.g., due to aging of devices or environmental changes). In some embodiments, the detection system incorporates an N-point calibration for normalization. In some embodiments, the detection system is calibrated by including unclassified objects. In some embodiments, the detection system is calibrated by excluding unclassified object classifications.

In some embodiments, the detection system detects devices for charging in the presence of safe objects (e.g., objects that are not harmed by the wireless power transmission). In some embodiments, the detection system disables charging and indicates error when unsafe objects (e.g., coins, paper clips, RFID tags, credit cards, metal) are present. In some embodiments, the detection system indicates active zones (i.e., zones where one or more objects are receiving power). In some embodiments, the detection system incorporates fault detection or handling (e.g., provide power back-off when unsafe objects are detected, provide alignment guide to guide user to resolve failure by removing objects, shifting receivers, etc.).

In wireless power transmission systems, the transmitter is designed to match the load impedance or reactance of the receiver for optimal power transfer. This impedance matching is affected by many factors, such as matching receiving and transmitting antenna, output load of receivers, antenna angle and position with respect to transmitter and receiver, obstructions between transmitter and receiver within the charging zones, temperature, and system to system variations (sometimes called wireless power hardware variations). These factors are either directly or indirectly observed as measurable electrical changes stimulated by a power beacon (e.g., short low power burst(s) sweeping over different power levels, frequency, position, etc. into a charging zone). In some embodiments, these electrical measurements (e.g., reflective power, forward power, drive current, drive voltage, temperature, etc.) are captured during the beacon and saved as a set of feature values. In some embodiments, the feature values are processed by the transmitter to yield a classification and decision. Selection of the features is critical to the classification performance. Each hardware architecture generates a different set of features which can be numerous, especially when different beacons are iterated over power, frequency and position.

FIGS. 3A-3F illustrate an example of the feature permutation for a hardware architecture. Not all features are optimal or useful for classification and often many combinations (of the features) are not obvious (for automatic inference). For example, in some orientations, a first object in the charging zone may appear to be another object (from the perspective of its impedance). FIGS. 3A-3F show a pair plot where each feature has been plotted against every other feature. The common labels are on the far left and near the bottom of the respective images. The features illustrated in FIGS. 3A-3F are various ADC values available in the hardware and the grouping represent different objects (ERX, NOLOAD, etc.). The colors (orange, and blue) corresponds to labels. In this case it is either a ‘noload’ (i.e., empty) or ‘erx.’ Although, in practice, there can be many clusters, FIGS. 3A-3F are simplified illustrations. In particular, some features were removed to show a more zoomed in view of the illustration. As illustrated, there are at least 7 features: adc1_0, adc2_0 (IdPA), adc3_0, adc4_0, pdet1_0 (power detector), pdet0_0, ts_0 (temperature), according to some embodiments. These 7 features are plotted against each other, so that there are 7×7 subplots. The middle diagonal is a distribution which can be ignored, since plotting a feature against itself doesn't have any meaning. The lower triangle (i.e., the triangle below the diagonal) is a mirror of the upper triangle (i.e., the triangle above the diagonal). So, as illustrated, there are really only 21 combinations: (all combinations—diagonal) divided by 2=(7×7−7)/2=21 combinations. Some subplots show very poor separation (e.g., adc1_0 vs adc4_0) between the different colors. This means that it is not easy to tell from those features if the ‘label’ is ‘noload’ or ‘erx’. Some plots show separation of features, but there is no clear separation, because the result is dominated by a single feature (e.g., adc2_0 vs ts_0 (temperature)). Some features are easier for a software to categorize (e.g., adc2_0 (IdPA) vs pdet0_0 (power detector)) than other features. Some embodiments select features that show a high degree of separation.

In some embodiments, the data collection process utilizes an automated gantry system, such as the system shown in FIG. 3G (e.g., a robot with 4-5 degrees of freedom), that iterates through a set of objects representing receiver, no-load, and various foreign objects placed in a charging zone. In some embodiments, the robot gantry system places an object at a predetermined position and orientation. Power is transmitted and signals or features are sampled. Optionally, the tests are run over temperature (sometimes called temperature cycling: e.g., by changing temperature in the environment using an oven) if compensation is required. In some embodiments, the sampled data is stored in a data warehouse. In some embodiments, a first object (e.g., a key, coin, or other type of foreign object) is swapped and another object (e.g., a different foreign object, such as a different key, different coin, or another type of foreign object) is placed and the sampling process is repeated. In some embodiments, multiple objects are placed or combined so as to train the machine learning models to detect the presence of more than one object. In some embodiments, the data collection process includes sweep or cycling of several features (e.g., power, frequency, zones, and antenna detune). In some embodiments, the data collection process includes feature unrolling (i.e., each feature in a separate column in a table of features). In some embodiments, the data collection process includes sweep sequencing of features.

The data collected is sampled into a labeled data set. In some embodiments, the collected data sets are aggregated and then processed by feature selection algorithms that look for features with the highest correlation. In some embodiments, data features are selected from the aggregated data set by both standard feature selection algorithms and by a tester or a developer (a user) using standard visualization tools (e.g., cluster visualization tools). In some embodiments, the process is iterated or repeated several times for better performance.

FIG. 3H illustrates a set of features selected by the above process. The x-axis and the y-axis each corresponds to a selected feature. The selected features show the most correlation to change in impedance, according to some embodiments. Once the features are selected, the data features are used in a supervised training of a set of candidate machine learning models that are evaluated for their performance. In some embodiments, other factors, such as robustness and ease of calibration, are also considered during model selection. Once models are trained, the models are integrated into the detection system. In some embodiments, the detection system employs multiple machine learning models, each model tuned to detect and/or classify objects in specific zones. In some embodiments, results from multiple models are combined. In some instances, it is easier to combine results from multiple simpler models than to design a more complex model. In some embodiments, the detection system employs multiple machine learning models, each model tuned to detect and/or classify specific types of objects.

In some embodiments, a KMeans algorithm (or classifier) classifies known and unknown objects based on the selected features. For example, in FIG. 3H, the different shades in the plot indicate classification, by a KMeans classifier, of different types of objects (no load, erx or receiver objects, and foreign objects), according to some embodiments. No load corresponds to absence of receivers and foreign objects in the zone. By way of experimentation, in some embodiments, a KMeans classifier is chosen to classify known and unknown objects, or to classify and/or to detect objects distinct from a known set of objects. In some embodiments, the KMeans classifier is used to detect specific devices for charging. In some embodiments, a k-nearest neighbors classifier (k-NN classifier) classifies specific set of objects, as illustrated in FIG. 3I, according to some embodiments. As shown in FIG. 3I, the k-NN classifier identifies a coin, a receiver (indicated as eRX), a tag (or a RFID tag), a card (e.g., a credit card), and, in some instances, the fact that the charging zone is empty (i.e., no objects are present), according to some embodiments.

In some embodiments, the sample data (sometimes called the data set) is split into a training set and a test set. The machine learning model is trained with different hyper-parameters using the training set, and the model's performance is evaluated with the test set. This process is repeated until a tuned model with the desired level of performance is created. The model is subsequently integrated and deployed in the detection system.

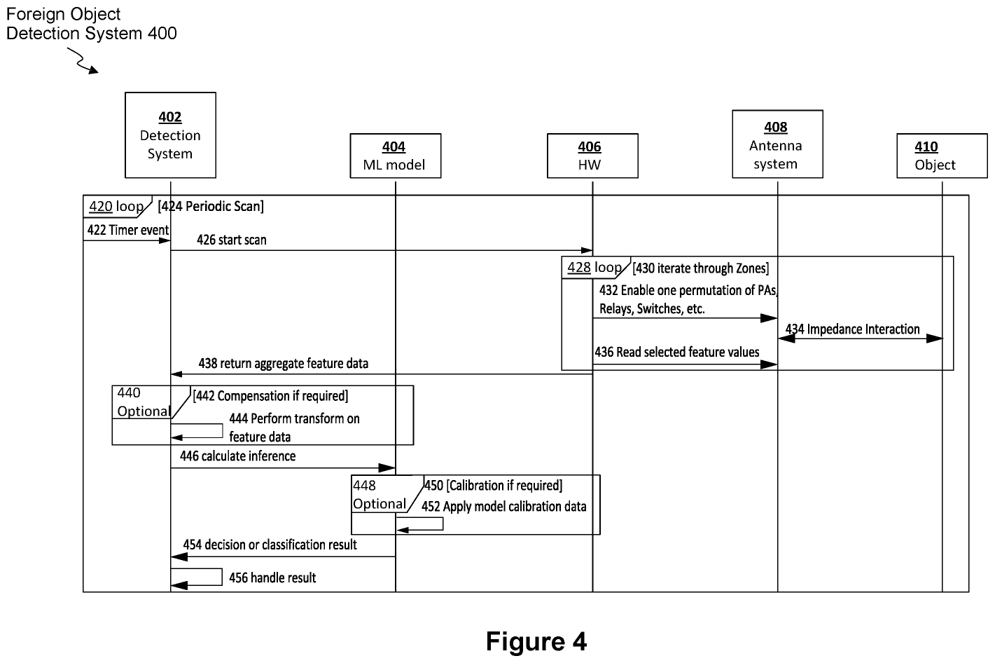

FIG. 4 is a sequence diagram of a machine learning-based foreign object detection system 400, in accordance with some embodiments. The foreign object detection system 400 operates in a loop (420) detecting and/or classifying objects in one or more charging zones. A power transmission hardware (HW) 406 (e.g., the RF charging pad 100, FIG. 1B) operates in a continuous loop (428), iterating (430) through different permutations (432) of power amplifier (PA) zones (sometimes called charging zones), power levels, switches, frequency, etc. The HW 406 enables the antenna system 408 to transmit power (sometimes called power beacons, beacons, or beacon signals) using the transmission parameters (corresponding to each permutation) during each iteration. The HW 406 also samples (436), from the antenna system 408 (e.g., which includes the antennas 210, FIG. 1B), analog readings from the selected set of features representing key hardware points in the system. The impedance interaction between the antenna system 408 and the object 410 is indicated by the label 434 (e.g., this impedance interaction involves the PA IC 161A receiving impedance measurements from various measurement points along one or more of the PAs 108). The HW module 406 returns (438) aggregate feature data (i.e., a collection of feature data at the end of the loop 428) to the detection system 402 (described above in reference to FIGS. 3A-3I). Optionally (440), the detection system 402 transforms (444) the sample data (sometimes called the feature data or the aggregate feature data), if required, to compensate (442) for environmental variations (e.g., board to board variations). In some embodiments, the transforming is performed by the RF IC 160, but certain operations can also be performed by the PA IC 161A in certain embodiments or circumstances.

Subsequently, the detection system 402 calculates (446) inference (i.e., detects and/or classifies objects) by inputting the feature data to the trained machine learning model 404 (described above). The machine learning model 404 returns (454) decision or classification result. The detection system 402 handles (456) or uses the result from the machine learning model 404 to drive higher level system behavior, such as to generate user alerts, to determine charging levels for objects, etc. In some embodiments, the detection system 402 and the ML model 404 reside on the RF IC 160, and these also operate based on the measurements received via the PA IC 161A.

In some embodiments, the machine learning model 404 optionally (448) applies (450) calibration (e.g., feature scaling, normalization of data) if required. In some embodiments, the machine learning model 404 applies (452) model calibration data. In some embodiments, the calibration step is performed at the time of manufacturing (sometimes called factory calibration) of the wireless power transmission system (that incorporates the foreign object detection system). Sometimes a user of the system performs a calibration procedure to recalibrate the system. Some embodiments perform auto calibration during operation. For example, some embodiments use reinforcement learning where small deviations that were categorized as chargeable are used to adjust the models' accuracy as the devices age. To further illustrate, in some embodiments, after a receiver is detected, the wireless power transmission system communicates with the receiver (e.g., using Bluetooth LE) to establish that sufficient power is received from the transmitter, thereby indicating that the coupling between the wireless power transmission system and the receiver is effective. This in turn indicates that the concerned feature vector has provided a reference for a true positive detection result. This observation is used to reinforce or adjust the stored calibrated points. In some embodiments, as receiver devices age, calibration points shift slowly so the auto calibration is used to auto correct the behavior of the transmission system. As another example, when the device is able to charge, the transmitter can record shifts and increase the adjustments weighting towards the new shift for each successful charging. If the charge is unsuccessful, then the weighting is diminished to counter the adjustments.

FIG. 5 is a flow diagram showing a process of detecting foreign objects (and receivers) using trained classifiers in accordance with some embodiments.

In some embodiments, a method 500 of detecting and classifying foreign objects is performed at a computer system (e.g., the system 100 as described above in reference to FIG. 2A, with the RF Power Transmitter IC 160 responsible for controlling operation of the method 500, based in part on the measurements received from the PA IC 161A). The computer system (e.g., the system 100) has one or more processors and memory storing one or more programs configured for execution by the one or more processors. The method includes obtaining (502) a plurality of electrical measurements (e.g., using the electrical measurements module 248, which operates in conjunction with the PA IC 161A) while a wireless-power-transmitting antenna (e.g., one of the antennas 210-A, . . . , 210-N) is transmitting different power beacons. The method also includes forming (504) a feature vector (e.g., by the feature vector module 250) according to the plurality of electrical measurements. The method further includes detecting (508) a presence of one or more foreign objects prior to transmitting wireless power to one or more wireless power receivers by inputting the feature vector to trained one or more classifiers (e.g., the classifier model(s) 264). Detecting presence can include detecting that the one or more foreign objects are located within a wireless-power-transmission range of the system, such as within a near-field wireless-power-transmission range of between 0 to 6 inches. Each classifier is a machine-learning model trained to detect foreign objects distinct from the one or more wireless power receivers. In some embodiments, the method includes determining (514) if foreign objects are detected and/or determining if receivers' absence is detected. In accordance with a determination that no foreign objects are detected and/or that receivers are present, the method further includes transmitting (516) power to the receivers. Example classifiers and the training processes are described above in the section titled “An Example Machine Learning Based Foreign Object Detection System.”

In some embodiments, each classifier is further trained to classify (510) foreign objects, and the method further includes classifying the one or more foreign objects into one or more categories. FIG. 3I (described above) provides an example of a classifier that can classify objects into a known list of categories, according to some embodiments.

In some embodiments, at least one respective power beacon of the different power beacons is transmitted at each of a plurality of antennas zones. Each zone corresponds to a distinct charging area. In some embodiments, each zone has an associated transmitting antenna, and all of the zones form a wireless-power-transmission system. Each of the transmitting antennas is responsible for sending power to a respective distinct charging area. FIGS. 1B and 1C (described above) illustrate an antenna array 290) and transmission zones 290-1 through 290-N, according to some embodiments. In the example shown in FIGS. 1B and 1C, each antenna (e.g., antenna 210-A, 210-N) are configured to transmit power to a respective power transfer zone. The method includes obtaining a respective set of electrical measurements for each zone of the plurality of zones. The method also includes forming the feature vector comprises calculating a respective feature data for each set of electrical measurements, and aggregating each feature data to obtain the feature vector.

In some embodiments, the method further includes, prior to inputting the feature vector to the trained one or more classifiers, transforming (506) the feature vector (e.g., by the feature vector module 250) to compensate for a predetermined set of conditions including environmental differences between when training the one or more classifiers to detect foreign objects and when operating the one or more classifiers to detect foreign objects (e.g., temperature, or board-to-board variation).

In some embodiments, the method further includes, applying (518), at a first classifier of the one or more classifiers that has a first machine-learning model, reinforcement learning to adjust (or recalibrate) one or more weights used in the first machine-learning model upon determining that (i) the first classifier has detected a presence of the one or more foreign objects and (ii) wireless power received by the one or more wireless power receivers indicates that no foreign object is present.

In some embodiments, the trained one or more classifiers detect that the one or more foreign objects are present (e.g., within a near-field wireless power transmission range of 0-6 inches from an outer surface of a housing that houses the RF charging pad 100). The method further includes continuing to (i) obtain the plurality of electrical measurements, (ii) form the feature vector, and (iii) detect that the one or more foreign objects are present by inputting the feature vector to the trained one or more classifiers. The method further includes waiting to transmit wireless power to the one or more wireless power receivers until the one or more classifiers stop detecting that the one or more foreign objects are present.

In some embodiments, each of the different power beacons is transmitted in an iterative fashion at each of a plurality of zones. Each zone corresponds to a distinct charging area of the wireless power transmitting antenna. The method includes obtaining a first set of electrical measurements for a first zone of the plurality of zones. The method also includes waiting to transmit wireless power to the one or more wireless power receivers until the one or more classifiers stop detecting that the one or more foreign objects are present in the first zone. FIG. 1B (described above) illustrates antenna 210-A configured to transfer power to zone 2901-1 and antenna 210-N configured to transfer power to zone 290-N, according to some embodiments. The circuit 160 controls the antenna array to iterate over the plurality of zones, according to some embodiments.

In some embodiments, the plurality of electrical measurements are obtained (e.g., obtained via the PA IC 161A based on electrical measurements at one of the PAs 108) at predetermined time intervals.

In some embodiments, the plurality of electrical measurements include measurements of one or more of: load impedance, reflective power, forward power, drive current, drive voltage, magnetics, and temperature. FIGS. 3A-3F (described above) illustrate several features or electrical measurements aimed at training classifiers for detecting and classifying foreign objects.

In some embodiments, each classifier is trained to detect one or more of: coins, credit cards, and RFID tags. For example, FIG. 3I (described above) illustrates classification of objects, according to some embodiments.

In some embodiments, the one or more classifiers are further trained to detect (512) a presence of a first wireless power receiver. FIGS. 3A-3I (described above) provide examples of training classifiers, according to some embodiments. In some embodiments, the classifiers are trained to detect the presence of specific one or more receivers, and can also detect whether or not each receiver is authorized to receive wireless power from the system (to avoid allowing unauthorized receivers to leech power from the system). The method further includes transmitting wireless power to the first wireless power receiver. The method also includes, while transmitting the wireless power to the first wireless power receiver, continuing to (i) obtain the plurality of electrical measurements, (ii) form the feature vector, and (iii) detect that the first wireless power receiver is present by inputting the feature vector to the trained one or more classifiers. The method also includes ceasing to transmit wireless power from the wireless power transmitting antenna to the first wireless power receiver when the one or more classifiers stop detecting the presence of the first wireless power receiver.

In some embodiments, the one or more classifiers are further trained to detect (512) a charging state of a first wireless power receiver. To illustrate, when a receiver's battery charges (e.g., because the receiver received power from the wireless power transmission system), the load impedance of the battery changes. This will result in the feature vector to change as the battery charges reaches full capacity. The one or more classifiers are trained to detect this change thereby detecting a charging state of the receiver. The method further includes transmitting wireless power to the first wireless power receiver. The method also includes, while transmitting the wireless power to the first wireless power receiver, continuing to (i) obtain the plurality of electrical measurements, (ii) form the feature vector, and (iii) detect the charging state of the first wireless power receiver by inputting the feature vector to the trained one or more classifiers. The method also includes ceasing to transmit wireless power from the wireless power transmitting antenna to the first wireless power receiver when the one or more classifiers detect that the charging state of the first wireless power receiver has reached a predetermined threshold.

In some embodiments, each power beacon of the different power beacons is transmitted as a low power burst (e.g., an electromagnetic signal that has 50% of a power level used for transmission of wireless power to a receiving device) for a short period of time (e.g., lasts for less than 1 second, as compared to transmitting higher-power signals for minutes at a time while transmitting wireless power to a receiving device). In some embodiments, each power beacon of the different power beacons is transmitted using transmission parameters selected from a predetermined set of transmission parameters specifying at least a power level and a frequency.

In some embodiments, the one or more classifiers include a K-means classifier trained to detect the one or more wireless power receivers and to distinguish the one or more wireless power receivers from the one or more foreign objects. A K-means classifier is described above in reference to FIG. 3H, according to some embodiments.

In some embodiments, the one or more classifiers include a k-nearest neighbor (k-NN) classifier trained to classify the one or more wireless power receivers and the one or more foreign objects into at least one category of a plurality of categories of objects. A k-NN classifier is described above in reference to FIG. 3I, according to some embodiments.

In some embodiments, the wireless-power-transmitting antenna is one of a plurality of wireless-power transmitting antennas. Each wireless-power-transmitting antenna associated with a respective charging area. Each classifier of the one or more classifiers is trained to detect presence of the one or more foreign objects only in a respective charging area. The method includes detecting the presence of the one or more foreign objects by inputting a respective subset of features of the feature vector corresponding to a respective charging area to a respective classifier of the one or more classifiers that is trained to detect foreign objects in the respective charging area.

In some embodiments, each classifier of the one or more classifiers is trained to detect a respective class of foreign objects. The method includes detecting the presence of the one or more foreign objects by inputting the feature vector to each classifier to detect the presence of each class of foreign objects. In some embodiments, the one or more classifiers is further trained to detect a presence of foreign objects between the wireless power transmitting antenna and a first wireless power receiver. The method further includes continuing to obtain the plurality of electrical measurements to form the feature vectors to detect the presence of the first foreign objects between the wireless power transmitting antenna and the first wireless power receiver. The method also includes ceasing to transmit wireless power from the wireless power transmitting antenna to the first wireless power receiver until the one or more classifiers stop detecting the presence of the one or more foreign objects.

In some embodiments, the wireless power transmitting antenna is configured to match the load impedance of the one or more wireless power receivers for optimal power transfer.

In some embodiments, the wireless-power-transmitting antenna is a near-field transmitting antenna. For example, the system 100 (described above) illustrates antennas 210-A through 210-N. In some embodiments, the near-field transmitting antenna is configured to transmit at a center frequency of between 30-50 MHz. In some embodiments, the near-field transmitting antenna is further configured to transmit at a sufficient power level to deliver 20 watts of usable power to the receiver. 20 watts is a high power delivery range beyond current capabilities of inductive-based charging techniques.

In some embodiments, the one or more classifiers are trained to detect foreign objects according to a set of features that show the most correlation to changes in impedance values. For example, FIGS. 3A-3F (described above) illustrates several electrical measurements or features, and FIG. 3H illustrates two features that show the most correlation to change in impedance, according to some embodiments. In some embodiments, the set of features includes drive current power amplifier drive current and/or power detectors for reflective power. In some embodiments, the set of features includes FWD and/or power detectors for reflective power of multiple zones.

FIG. 6A is a flow diagram 600 showing a process of using a trained classifier for detecting foreign objects in accordance with some embodiments that use a zone-based power transmission system (such as that shown in the example of FIG. 1B). Some embodiments detect a receiver 104 along with any foreign objects (such as keys, coins, or other objects that might be placed on or near the NF charging pad) by sending beacon signals (also referred to herein as “test power transmission signals”) periodically. In some embodiments, each power-transfer zone 290 starts (602) a timer so as to send the beacon signals periodically. In some embodiments, when the timer expires (604), each power-transfer zone 290 of the NF charging pad (also referred to herein as an RF charging pad) 100 sends a respective beacon signal (606). In some embodiments, at step 608, a signature-signal circuit of the transmitter (e.g., a component capable of receiving analog signals (such as reflected power measurements after a beacon signal is transmitted and then some part of it is reflected back) and converting them to a digital representation that forms a signature representing a foreign object) determines signature-signals after transmitting the beacon signal (the signature-signals representing one or more receivers and/or one or more foreign objects). The transmitter beacon signal is disabled (610), the samples from ADC are analyzed (612) to help determine the signature-signals discussed above, and the zone status is evaluated (614) (e.g., as discussed with reference to FIG. 5). After the zone status is determined and the matching between each respective zone and the receiver 104 is evaluated, the timer is restarted (616) to start the next period for sending beacon signals. In this way, each zone of the system is able to determine those objects (receivers and/or foreign objects) located nearby and can determine whether to transmit wireless power and, if so, any adjustments that should be made to account for presence of any foreign objects. In some embodiments, the start step (602) is preceded by an optional training process as discussed with reference to FIG. 6B.

FIG. 6B is a flow diagram 650 showing a process of optional training performed by the power-transfer zone 290 in accordance with some embodiments. In some embodiments, optional training includes aiding foreign object detection (FOD) using signature-signal-based detection. In some embodiments, this can be done at one time with known sets of receivers and FOD devices. In some embodiments, enough ADC samples are collected (652) to enable classification of FOD, and the derived parameters provide the ability to classify the object detection status including (1) no object present (654), (2) one or more foreign objects present (654), (3) receiver only present (658), and (4) foreign object in between the receiver 104 and the power-transfer zone 290 (660). The process further includes analyzing (662) ADC samples to derive FOD parameters, and storing (664) the FOD in memory (e.g., in non-volatile memory). More details regarding example training or learning processes are described above in reference to FIG. 5, and can involve use of the gantry robot to allow for automation of the optional training process and enable training for many types of receivers and foreign objects in a short period of time.

All of these examples are non-limiting and any number of combinations and multi-layered structures are possible using the example structures described above.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

It will also be understood that, although the terms “first,” “second,” etc. may be used herein to describe various elements, these elements should not be limited by these terms. These terms are only used to distinguish one element from another. For example, a first region could be termed a second region, and, similarly, a second region could be termed a first region, without changing the meaning of the description, so long as all occurrences of the “first region” are renamed consistently and all occurrences of the “second region” are renamed consistently. The first region and the second region are both regions, but they are not the same region.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. (canceled)

2. A non-transitory, computer-readable storage medium storing instructions that, when executed by one or more processors of a wireless-power transmitter including a wireless-power-transmitting antenna, cause the wireless-power transmitter to perform operations, comprising:
after the wireless-power transmitter has been enabled for a predetermined period of time, for each zone of a plurality of zones;
enabling a beacon signal,
obtaining a set of electrical measurements;
disabling the beacon signal, and
determining, using a trained classifier configured to receive the set of electrical measurements, a zone status indicating presence of a foreign object within a respective zone of the plurality of zones;
in accordance with a first zone status indicating that a foreign object is present within a first zone of the plurality of zones, forgo transmitting wireless power to one or more wireless power receivers within the first zone of the plurality of zones; and
in accordance with a second zone status indicating an absence of a foreign object within a second zone of the plurality of zones, transmitting wireless power to one or more wireless power receivers within the second zone of the plurality of zones.

3. The non-transitory computer readable storage medium of claim 2, wherein obtaining the set of electrical measurements for each zone of the plurality of zones further comprises forming a respective feature vector for each set of electrical measurements.

4. The non-transitory computer readable storage medium of claim 3, wherein the instructions, when executed by the one or more processors of the wireless-power transmitter, cause the wireless-power transmitter to perform operations, further comprising:
for each zone of a plurality of zones;
continuing to (i) obtain the set of electrical measurements, (ii) form the respective feature vector, and (iii) determine a respective zone status by inputting the respective feature vector to the trained classifier; and
waiting to transmit wireless power to the one or more wireless power receivers until the trained classifier stops detecting that the one or more foreign objects are present.

5. The non-transitory computer readable storage medium of claim 3, wherein forming the feature vector further comprises calculating a respective feature data for the set of electrical measurements, and aggregating the respective feature data to obtain the feature vector.

6. The non-transitory computer readable storage medium of claim 2, wherein the trained classifier includes a machine-learning model and applies reinforcement learning to adjust one or more weights used in the machine-learning model upon determining that (i) the trained classifier has detected the presence of the one or more foreign objects and (ii) wireless power received by the one or more wireless power receivers indicates that no foreign object is present.

7. The non-transitory computer readable storage medium of claim 2, wherein the trained classifier is further trained to classify the one or more foreign objects into one or more categories.

8. The non-transitory computer readable storage medium of claim 2, wherein the set of electrical measurements is obtained at predetermined time intervals.

9. The non-transitory computer readable storage medium of claim 2, wherein the set of electrical measurements include measurements of one or more of: load impedance, reflective power, forward power, drive current, drive voltage, magnetics, and temperature.

10. The non-transitory computer readable storage medium of claim 2, wherein the trained classifier detects one or more of: coins, credit cards, and radio-frequency identification (RFID) tags.

11. The non-transitory computer readable storage medium of claim 2, wherein the beacon signal is transmitted as a low power burst for a short period of time.

12. The non-transitory computer readable storage medium of claim 2, wherein the beacon signal is transmitted using transmission parameters selected from a predetermined set of transmission parameters specifying at least a power level and a frequency.

13. The non-transitory computer readable storage medium of claim 2, wherein the trained classifier includes a K-means classifier trained to detect the one or more wireless power receivers and to distinguish the one or more wireless power receivers from the one or more foreign objects.

14. The non-transitory computer readable storage medium of claim 2, wherein the trained classifier includes a k-nearest neighbor (k-NN) classifier trained to classify the one or more wireless power receivers and the one or more foreign objects into at least one category of a plurality of categories of objects.

15. The non-transitory computer readable storage medium of claim 2, wherein the wireless-power-transmitting antenna is configured to match load impedance of the one or more wireless power receivers for optimal power transfer.

16. The non-transitory computer readable storage medium of claim 2, wherein the wireless-power-transmitting antenna is a near-field transmitting antenna.

17. A wireless-power transmitter, comprising:
a wireless-power-transmitting antenna;
one or more processors; and
memory storing one or more programs that are configured for execution by the one or more processors, the one or more programs including instructions for;
after the wireless-power transmitter has been enabled for a predetermined period of time, for each zone of a plurality of zones;
enabling a beacon signal,
obtaining a set of electrical measurements;
disabling the beacon signal, and
determining, using a trained classifier configured to receive the set of electrical measurements, a zone status indicating presence of a foreign object within a respective zone of the plurality of zones;
in accordance with a first zone status indicating that a foreign object is present within a first zone of the plurality of zones, forgo transmitting wireless power to one or more wireless power receivers within the first zone of the plurality of zones; and
in accordance with a second zone status indicating an absence of a foreign object within a second zone of the plurality of zones, transmitting wireless power to one or more wireless power receivers within the second zone of the plurality of zones.

18. The wireless-power transmitter of claim 17, wherein obtaining the set of electrical measurements for each zone of the plurality of zones further comprises forming a respective feature vector for each set of electrical measurements.

19. The wireless-power transmitter of claim 18, wherein the one or more programs stored in the memory further include instructions for;
for each zone of a plurality of zones;
continuing to (i) obtain the set of electrical measurements, (ii) form the respective feature vector, and (iii) determine a respective zone status by inputting the respective feature vector to the trained classifier; and
waiting to transmit wireless power to the one or more wireless power receivers until the trained classifier stops detecting that the one or more foreign objects are present.

20. A method of detecting and classifying foreign objects, comprising:
after a wireless-power transmitter including a wireless-power-transmitting antenna has been enabled for a predetermined period of time, for each zone of a plurality of zones of the wireless-power transmitter;
enabling a beacon signal,
obtaining a set of electrical measurements;
disabling the beacon signal, and
determining, using a trained classifier configured to receive the set of electrical measurements, a zone status indicating presence of a foreign object within a respective zone of the plurality of zones;
in accordance with a first zone status indicating that a foreign object is present within a first zone of the plurality of zones, forgo transmitting wireless power to one or more wireless power receivers within the first zone of the plurality of zones; and
in accordance with a second zone status indicating an absence of a foreign object within a second zone of the plurality of zones, transmitting wireless power to one or more wireless power receivers within the second zone of the plurality of zones.

21. The method of claim 20, wherein obtaining the set of electrical measurements for each zone of the plurality of zones further comprises forming a respective feature vector for each set of electrical measurements.
